(19) United States
(12) Patent Application Publication
(10) Pub. No.: US 2024/0181739 A1
(43) Pub. Date: Jun. 6, 2024

(54) CELLULOSE PRODUCT TOGGLE PRESSING MODULE AND METHOD FOR USING THE SAME

(71) Applicant: PulPac AB, Västra Frölunda (SE)

(72) Inventors: Olle Högblom, Göteborg (SE); Ove Larsson, Västra Frölunda (SE); Martin Ljungberg, Göteborg (SE); Edward Guidotti, Göteborg (SE); Björn Arlerot, Göteborg (SE); Patrik Larsson, Kärna (SE)

(21) Appl. No.: 18/285,619

(22) PCT Filed: Apr. 8, 2022
(86) PCT No.: PCT/EP2022/059510

§ 371 Date: Oct. 4, 2023

(30) Foreign Application Priority Data
Apr. 15, 2021 (WO) PCT/EP2021/059810
Apr. 15, 2021 (WO) PCT/EP2021/059811
Dec. 23, 2021 (SE) 2151618-2

(51) Int. Cl. B31F 1/00; B30B 1/16; B30B 11/00; B31B 50/00; B31B 50/10; B31B 50/59

(52) U.S. Cl. CPC B31F 1/0077; B30B 1/16; B30B 11/005; B31B 50/006; B31B 50/102; B31B 50/59

(57) ABSTRACT

A product forming unit for manufacturing non-flat cellulose products from an air-formed cellulose blank structure (2). The product forming unit includes a blank dry-forming module with a moveable forming wire, a toggle pressing module with a toggle press and a forming mold, and an electronic control system operatively connected to the forming wire and the toggle press. The blank dry-forming module is configured for air-forming the cellulose blank structure onto the forming wire. The toggle press includes a pressing member movably arranged in a pressing direction, a toggle-mechanism drivingly connected to the pressing member, and a pressing actuator arrangement drivingly connected to the toggle-mechanism. The forming mold includes a moveable first mold part attached to the pressing member and a second mold part. The electronic control system is configured for controlling operation of the pressing actuator arrangement for performing pressing operations, which involves driving the pressing member in the pressing direction by the toggle-mechanism, and thereby forming the non-flat cellulose product from the air-formed cellulose blank structure by pressing the first mold part against the second mold part. The electronic control system is configured for intermittently feeding the forming wire between subsequent pressing operations.

### TECHNICAL FIELD

The present disclosure relates to a cellulose product toggle pressing module for forming non-flat cellulose products from an air-formed cellulose blank structure. The disclosure further relates to a method for forming non-flat cellulose products from an air-formed cellulose blank structure using a cellulose product toggle pressing module.

The cellulose product toggle pressing module according to the disclosure will be described primarily in relation to an example cellulose product forming unit having integrated fiber separating module, cellulose blank air-forming module, etc., but cellulose product toggle pressing module and associated method for using the same is not limited to this specific implementation and may alternatively be implemented and used in many other types of cellulose products manufacturing systems.

### BACKGROUND

Cellulose fibers are often used as raw material for producing or manufacturing products. Products formed of cellulose fibers can be used in many different situations where there is a need for having sustainable products. A wide range of products can be produced from cellulose fibers and a few examples are disposable plates and cups, cutlery, lids, bottle caps, coffee pods, and packaging materials.

Forming molds are commonly used when manufacturing cellulose products from cellulose fiber raw materials, and traditionally the cellulose products are wet-formed. A material commonly used for wet-forming cellulose fiber products is wet molded pulp. Wet molded pulp has the advantage of being considered as a sustainable packaging material, since it is produced from biomaterials and can be recycled after use. Consequently, wet molded pulp has been quickly increasing in popularity for different applications. Wet molded pulp articles are generally formed by immersing a suction forming mold into a liquid or semi liquid pulp suspension or slurry comprising cellulose fibers, and when suction is applied, a body of pulp is formed with the shape of the desired product by fiber deposition onto the forming mold. With all wet-forming techniques, there is a need for drying of the wet molded product, where the drying is a very time and energy consuming part of the production. The demands on aesthetical, chemical and mechanical properties of cellulose products are increasing, and due to the properties of wet-formed cellulose products, the mechanical strength, flexibility, freedom in material thickness, and chemical properties are limited. It is also difficult in wet-forming processes to control the mechanical properties of the products with high precision.

One development in the field of producing cellulose products is the forming of cellulose fibers in a dry-forming process, without using wet-forming. Instead of forming the cellulose products from a liquid or semi liquid pulp suspension or slurry, an air-formed cellulose blank structure is used. The air-formed cellulose blank structure is inserted into forming molds and during the forming of the cellulose products the cellulose blank structure is subjected to a high forming pressure and a high forming temperature in the forming molds.

Manufacturing of cellulose products by compression molding of an air-formed cellulose blank structure may be performed in production lines or product forming units. The manufacturing equipment commonly includes a pressing module comprising the forming molds. Other modules and components are arranged in connection to the pressing module, such as for example feeding modules, and blank dry forming modules. The pressing module is normally a high capacity pressing module, such as large hydraulic or servo powered pressing machines, which may be used for forming other materials such as steel plates, since these modules are available as stand-alone off-the shelf machinery.

One drawback of using a standard pressing module developed for general purposes is the high cost typically associated with a conventional high capacity hydraulic or servo powered pressing machine, as well as problems caused by their large size and weight in terms of shipping, installation, maintenance and factory size.

Moreover, the customer normally investing in cellulose product forming units is called converter and has typically no or little skill in the engineering required to develop and integrate the necessary modules for a complete cellulose product forming unit, and there is thus a desire among converters to be able to purchase complete, fully integrated, standardized production forming units, that may be easily shipped, installed and made to run.

There is thus a need for a low-cost, compact and less heavy cellulose product pressing module for forming non-flat cellulose products from an air-formed cellulose blank structure, as well as a method for forming non-flat cellulose products from an air-formed cellulose blank structure using such a cellulose product pressing module. There is also a need for a cellulose product pressing module that enables development and manufacturing of low-cost, compact, fully integrated, standardized cellulose product forming units that may be easily shipped, installed and made to run.

### SUMMARY

An object of the present disclosure is to provide a cellulose product pressing module for forming non-flat cellulose products from an air-formed cellulose blank structure, as well as an associated method for forming non-flat cellulose products from an air-formed cellulose using such a pressing module, where the previously mentioned problems are avoided. This object is at least partly achieved by the features of the independent claims.

According to a first aspect of the present disclosure, there is provided a product forming unit for manufacturing non-flat cellulose products from an air-formed cellulose blank structure. The product forming unit comprises a blank dry-forming module with a moveable forming wire, a toggle pressing module with a toggle press and a forming mold, and an electronic control system operatively connected to the forming wire and the toggle press; wherein the blank dry-forming module is configured for air-forming the cellulose blank structure onto the forming wire; wherein the toggle press includes a pressing member movably arranged in a pressing direction, a toggle-mechanism drivingly connected to the pressing member, a pressing actuator arrangement drivingly connected to the toggle-mechanism; wherein the forming mold includes a moveable first mold part attached to the pressing member and a second mold part; wherein the electronic control system is configured for controlling operation of the pressing actuator arrangement for performing pressing operations, which involves driving the pressing member in the pressing direction by means of the toggle-mechanism, and thereby forming the non-flat cellulose product from the air-formed cellulose blank structure by pressing the first mold part against the second mold part; and wherein the electronic control system further is configured for intermittently feeding the forming wire between subsequent pressing operations.

According to a second aspect of the present disclosure, there is provided a method for forming non-flat cellulose products from an air-formed cellulose blank structure in a product forming unit that comprises a blank dry-forming module with a moveable forming wire, a toggle pressing module with a toggle press and a forming mold, and an electronic control system operatively connected to the forming wire and the toggle pressing module. The toggle press includes a pressing member movably arranged in a pressing direction, a toggle-mechanism drivingly connected to the pressing member, a pressing actuator arrangement drivingly connected to the toggle-mechanism. The forming mold includes a moveable first mold part attached to the pressing member and a second mold part. The method comprises: air-forming a cellulose blank structure onto the forming wire by means of the blank dry-forming module; feeding the air-formed cellulose blank structure into a pressing area defined by the first and second, spaced apart, mold parts; controlling operation of the pressing actuator arrangement by means of the electronic control system for performing pressing operations, which involves driving the pressing member in the pressing direction by means of the toggle-mechanism, and thereby forming the non-flat cellulose product from the air-formed cellulose blank structure by pressing the first mold part against the second mold part; and controlling operation of the forming wire by means of the electronic control system for intermittently feeding the forming wire between subsequent pressing operations.

Toggle mechanism clamps are well known in the field of injection molding, where for example a plastic material in a liquid phase is injected with high pressure into a cavity formed by a closed mold. In the technical field of injection molding, the purpose of the toggle mechanism clamp is merely to close the injection mold parts and to exert a sufficient clamping force to avoid separation of the mold parts due to internal injection pressure within the mold.

However, toggle mechanism is less commonly used for compression molding applications, in which the pressure level typically is a relevant parameter that may have to be controlled with a certain accuracy, partly because control of pressing force is more complicated due to the exponential amplification character of the toggle mechanism, and partly because the resulting pressing force cannot be easily determined with good accuracy. For example, the pressing force generated by a pressing actuator arrangement on the toggle mechanism approaches zero when the toggle mechanism approaches the force equilibrium position, thereby rendering the pressing force of the pressing actuator arrangement less useful for determining pressing force.

On the other hand, toggle presses have, compared with conventional high capacity hydraulic or servo presses, the advantage of being relatively compact and low-cost due to the low input pressing force requirement. In other words, a relatively small capacity actuator, such as a small capacity hydraulic or pneumatic linear actuator, i.e. cylinder-piston arrangement, or low power electric motor driven ball-screw linear actuator, may be sufficient for driving the toggle mechanism and thereby generating a significantly larger pressing force.

Moreover, the toggle press also has an inherent highly beneficial speed-force characteristic that enables significant reduction in cycle time of the cellulose product forming cycle, compared with conventional high capacity hydraulic or servo presses. Specifically, the inherent force amplification characteristic of the toggle mechanism results in a relatively fast speed of the pressing member during an initial cycle time, starting from the standby position, while the speed is gradually reduced when approaching the maximal stroke state of the toggle mechanism in benefit for increased maximal pressing force. Hence, the initial motion of the pressing member is associated with high speed and low maximal pressing force, and motion of the pressing member during the actual pressing action is associated with low speed and high maximal pressing force.

In addition, by having the electronic control system configured for intermittently feeding the forming wire between subsequent pressing operations, the need for a relatively large, complex and costly buffer apparatus arranged in the region between the blank dry-forming module and pressing module is eliminated, thereby further assisting in reducing overall cost of the product forming unit.

Moreover, the compact size and low weight of the toggle press enables development of a very compact, complete, fully integrated, standardized cellulose product forming unit, that may be easily shipped, installed and made to run, and the low cost for a toggle press helps keeping the total cost for the cellulose product forming unit at a low level.

Further advantages are achieved by implementing one or several of the features of the dependent claims. For example, in some example embodiments, which may be combined with any one or more of the above-described embodiments, said pressing operations involves driving the pressing member in the pressing direction by setting the toggle-mechanism a maximal extended operating position, i.e. aligned first and second link members of the toggle-mechanism. This enables simplified control of the actuator arrangement used for driving the toggle-mechanism, because the control may be performed using for example position of the pressing member, or similarly easily detectable parameter, as feedback signal. Furthermore, when operating in the aligned link member operating region of the toggle press, the target pressing force is relatively easily and robustly accomplished, compared with working for example near the asymptotic operating region associated with the non-aligned link member operating region of the toggle press.

In some example embodiments, which may be combined with any one or more of the above-described embodiments, the toggle press is installed, or arranged for being installed, with the pressing direction of the pressing member arranged primarily in a horizontal direction, specifically with the pressing direction of the pressing member arranged within 20 degrees from the horizontal direction, and more specifically with the pressing direction in parallel with the horizontal direction. The primarily horizontal orientation of the toggle press enables low build height of the cellulose product forming unit, and a non-straight material flow of a continuous air-formed cellulose blank structure from a blank dry-forming module to the pressing module. A non-straight material flow, e.g. routing of a continuous air-formed cellulose blank structure in a first direction, such as for example upwards and subsequently in a second direction, such as for example downwards, generally enables development and manufacturing of a more compact cellulose product forming unit. Since a web of cellulose fiber material is typically supplied to the pressing module at about right angles to the pressing direction of the pressing module, a primarily horizontal orientation of the toggle press is typically associated with a primarily vertically arranged supply flow of the cellulose blank structure Consequently, it is clear that a primarily horizontally arranged pressing module is highly beneficial when developing a compact cellulose product forming unit having a non-straight material flow of an air-formed cellulose blank structure from a blank dry-forming module to the pressing module.

In some example embodiments, which may be combined with any one or more of the above-described embodiments, the electronic control system is configured for intermittently feeding the forming wire between subsequent pressing operations, such that the forming wire is operated periodically with a relatively high speed during time periods between subsequent pressing operations, and with a relatively low speed, or zero speed, during time periods coinciding with pressing operations. Thereby, the need for a relatively large, complex and costly buffer apparatus arranged in the region between the blank dry-forming module and pressing module may be eliminated, thereby further assisting in reducing overall cost of the product forming unit.

In some example embodiments, which may be combined with any one or more of the above-described embodiments, the electronic control system is configured for synchronized operation of the forming wire and the toggle press, such that the forming wire is operated, or operated with a relatively high speed, during time periods when the toggle press is a non-pressing state, and such that the forming wire is in stillstand state, or operating with a relatively low speed, during time periods when the toggle press is a pressing state. As a result, the need for a relatively large, complex and costly buffer apparatus arranged in the region between the blank dry-forming module and pressing module is reduced, thereby further assisting in reducing overall cost of the product forming unit.

In some example embodiments, which may be combined with any one or more of the above-described embodiments, the electronic control system is configured for controlling operation of forming wire and the toggle press, such that the feeding speed of the forming wire, in particular over a complete pressing cycle, is equal to, or at least substantially equal to, the feeding speed of the air-formed cellulose blank structure entering the forming mold. As a result, the need for a relatively large, complex and costly buffer apparatus arranged in the region between the blank dry-forming module and pressing module is eliminated, thereby further assisting in reducing overall cost of the product forming unit.

In some example embodiments, which may be combined with any one or more of the above-described embodiments, the product forming unit is free from a buffering module arranged between the blank dry-forming module and the toggle pressing module. The omission of the buffering module results in a more cost-efficient product forming unit.

In some example embodiments, which may be combined with any one or more of the above-described embodiments, the toggle press further includes: a pressing force indicating arrangement; an adjustment mechanism for enabling adjustment of a distance between the first and second mold parts in the pressing direction while having the toggle-mechanism in a non-moving operating state; and an adjustment actuator arrangement configured for driving the adjustment mechanism, wherein the electronic control system is operatively connected to the pressing force indicating arrangement and configured to control operation of the adjustment actuator arrangement, based on pressing force indicating feedback information received from the pressing force indicating arrangement. Thereby, the operating position of the toggle press may be adjusted to better fit and/or adapt to the specific characteristic of the cellulose blank structure and forming mold shape.

In some example embodiments, which may be combined with any one or more of the above-described embodiments, the electronic control system is configured to control operation of the adjustment actuator arrangement for adjusting the distance between the first and second mold parts during a time period between consecutive pressing actions, such that the pressing member during the next pressing cycle is targeted to provide a compression force closer to a predetermined target pressing force. Thereby, the operating position of the toggle press may be adjusted to better fit and/or adapt to the specific characteristic of the cellulose blank structure and forming mold shape.

In some example embodiments, which may be combined with any one or more of the above-described embodiments, the pressing force indicating arrangement includes one or more of the following sensors: a load cell, a deformation sensor, or a strain gauge force sensor, and wherein said one or more sensors is located at or within the forming mold, or on the toggle-mechanism, or between the toggle mechanism and a rear structure of a rigid frame structure of the toggle press, or between the toggle-mechanism and the forming mold, or at the rigid frame structure of the toggle press, or at a tie bar of an intermediate linear guiding arrangement of the toggle press. Thereby, reliable and accurate estimation of the resulting pressing force may be determined.

In some example embodiments, which may be combined with any one or more of the above-described embodiments, the toggle press further includes a front structure and a rear structure, wherein the toggle-mechanism is connected to the rear structure, wherein the second mold part is attached to the front structure, and wherein the mechanical adjustment mechanism enables adjustment of a distance between the front structure and rear structure, in the pressing direction, for enabling adjustment of a distance between the first and second mold parts while having the toggle-mechanism in a non-moving operating state. This enables a compact and cost-efficient pressing module.

In some example embodiments, which may be combined with any one or more of the above-described embodiments, each of the first and second mold parts comprises a main rigid plate-shaped body with a surface configured for facing the other mold part, and at least one pressing surface defining one or more forming cavities for forming a cellulose product, and with or without additional minor parts, such as spring-loaded cutting devices and/or mold alignment devices, or the like, wherein said surfaces of the main rigid plate-shaped body of the first and second mold forming parts are free from mutual direct contact during a pressing cycle. Thereby, the forming mold may be used for press forming of a non-flat cellulose product with a certain forming pressure without undesired interference between said surfaces.

In some example embodiments, which may be combined with any one or more of the above-described embodiments, the forming mold is configured for forming the cellulose products from the cellulose blank structure by heating the cellulose blank structure to a forming temperature in the range of 100-300° C., and pressing the cellulose blank structure with a forming pressure in the range of 1-100 MPa, preferably 4-20 MPa. These parameters are providing an efficient forming of the cellulose products, where strong hydrogen bonds are formed.

In some example embodiments, which may be combined with any one or more of the above-described embodiments, the blank dry-forming module further comprises a mill and a forming chamber, wherein the forming wire is arranged in connection to the forming chamber, wherein the mill is configured for separating fibers from a cellulose raw material, wherein the forming chamber is configured for distributing the separated fibers onto a forming section of the forming wire for forming the cellulose blank structure. The mill and forming chamber enables forming of the cellulose blank structure in close connection to the pressing module, without the need for pre-fabricating the cellulose blank structure, such that a compact layout can be achieved, and operation of the product forming unit is efficient with the cellulose raw material used as input material for in-line production of the cellulose blank structure.

In some example embodiments, which may be combined with any one or more of the above-described embodiments, the forming section of the forming wire is extending in an upwards blank forming direction. This enables designing a more compact and shorter product forming unit, because the air-formed cellulose blank structure is at least initially routed upwards, and thus not only in the horizontal direction.

In some example embodiments, which may be combined with any one or more of the above-described embodiments, the blank dry-forming module is configured for air-forming discrete cellulose blanks onto the forming wire, or wherein the blank dry-forming module is configured for air-forming a continuous cellulose blank structure onto the forming wire. Forming discrete cellulose blanks onto the forming wire may in certain implementations result in reduced level of residual material after forming, thereby reducing cost for raw material.

In some example embodiments, which may be combined with any one or more of the above-described embodiments, the pressing operation is a single pressing operation.

In some example embodiments, which may be combined with any one or more of the above-described embodiments, the product forming unit is adapted for intermittently feeding the cellulose blank structure from the blank dry-forming module by the forming wire in a first feeding direction, and for intermittently feeding the cellulose blank structure to the pressing module in a second feeding direction, wherein the second feeding direction differs from the first feeding direction, specifically wherein the second feeding direction is opposite to, or essentially opposite to, the first feeding direction. The differing feeding directions enable the modules to be integrated into one single unit or machinery possible to ship in a freight container, place on a converter's plant floor, connect and start production in a few months with no or very little module engineering skill required from the converter. Further advantages are that the differing feeding directions enable a more compact layout and construction of the product forming unit. With this configuration, the modules can be positioned in relation to each other in a non-conventional manner for an efficient and compact layout. Moreover, the integrated module design enables the weight of the production forming unit to be several times less than today's units with aligned discrete separately purchased modules into a custom-made industrial line. The weight of machinery commonly relates to the purchase price, why this solution also lowers the investment costs with several times for the converter. The lower investment costs enable a faster conversion to products made of cellulose raw materials instead of plastic materials.

In some example embodiments, which may be combined with any one or more of the above-described embodiments, the first feeding direction is an upwards direction and the second feeding direction is a downwards direction. This enables a smart and efficient layout of the product forming unit, where the unit can be built in a vertical direction for a compact layout.

In some example embodiments, which may be combined with any one or more of the above-described embodiments, the product forming unit further comprises a cellulose blank transport device, in particular a conveyer belt and/or a set of feeding rollers, configured for transporting the air-formed cellulose blank structure from forming wire of the blank dry-forming module to the forming mold of the toggle pressing module, wherein the electronic control system is configured for providing substantially synchronized operation of the forming wire and transport device. Thereby, the need for a costly cellulose blank buffer device may be eliminated.

In some example embodiments, which may be combined with any one or more of the above-described embodiments, the electronic control system is configured continuously operating the mill; and continuously feeding the cellulose raw material to the mill, or intermittently feeding the cellulose raw material to the mill.

In some example embodiments, which may be combined with any one or more of the above-described embodiments, the product forming unit further comprises a blank recycling module configured for transporting residual parts of the cellulose blank structure from the pressing module to the blank dry-forming module. The transportation of the residual parts is securing that non-used parts of the cellulose blank structure can be re-used.

In some example embodiments, which may be combined with any one or more of the above-described embodiments, the blank recycling module comprises a recycling compacting unit configured for compacting the residual parts of the cellulose blank structure in the recycling compacting unit upon transportation from the pressing module to the blank dry-forming module. By compacting the residual parts, an efficient operation in the mill is achieved.

In some example embodiments, which may be combined with any one or more of the above-described embodiments, the method comprises controlling operation of the forming wire by means of the electronic control system for intermittently feeding the forming wire between subsequent pressing operations, such that the forming wire is operated periodically with a relatively high speed during time periods between subsequent pressing operations, and with a relatively low speed, or zero speed, during time periods coinciding with pressing operations.

In some example embodiments, which may be combined with any one or more of the above-described embodiments, the method comprises controlling operation of the forming wire and the pressing actuator arrangement for synchronized operation of the forming wire and the toggle press, such that the forming wire is operated, or operated with a relatively high speed, during time periods when the toggle press is a non-pressing state, and such that the forming wire is in stillstand state, or operating with a relatively low speed, during time periods when the toggle press is a pressing state.

In some example embodiments, which may be combined with any one or more of the above-described embodiments, the method comprises controlling operation of forming wire and the toggle press by means of the electronic control system, such that the feeding speed of the forming wire is equal to, or at least substantially equal to, the feeding speed of the air-formed cellulose blank structure entering the forming mold.

In some example embodiments, which may be combined with any one or more of the above-described embodiments, the method comprises controlling operation of the adjustment actuator arrangement for adjusting the distance between the first and second mold parts during a time period between consecutive pressing actions, such that the pressing member during the next pressing cycle is targeted to provide a compression force closer to a predetermined target pressing force.

In some example embodiments, which may be combined with any one or more of the above-described embodiments, the step of air-forming the cellulose blank structure from the cellulose raw material in the blank dry-forming module involves: separating fibers from the cellulose raw material in a mill and distributing the separated fibers onto a forming wire of the blank dry-forming module for forming the cellulose blank structure, and transporting the formed cellulose blank structure in the upwards blank forming direction. The non-conventional upwards extension of the forming section is enabling a compact layout of the product forming unit, since the cellulose blank structure can be formed in an upwards direction and subsequently re-directed for transportation to the pressing module.

In some example embodiments, which may be combined with any one or more of the above-described embodiments, the cellulose blank structure is air-formed in the dry-forming module into a discrete cellulose blank, or wherein the cellulose blank structure is air-formed in the dry-forming module into a continuous cellulose blank.

In some example embodiments, which may be combined with any one or more of the above-described embodiments, the cellulose blank structure is intermittently transported from the blank dry-forming module by the forming wire in a first feeding direction, and intermittently transported to the pressing module in a second feeding direction, wherein the second feeding direction differs from the first feeding direction, specifically wherein the second feeding direction is opposite to, or essentially opposite to, the first feeding direction.

In some example embodiments, which may be combined with any one or more of the above-described embodiments, the method further comprises the steps: continuously operating the mill; and continuously feeding the cellulose raw material to the mill, or intermittently feeding the cellulose raw material to the mill. Thereby, the composition of the resulting air-laid the cellulose blank structure may be altered and adapted according to the specific circumstances.

In some example embodiments, which may be combined with any one or more of the above-described embodiments, the forming wire comprises a forming section arranged in connection to a forming chamber opening of the forming chamber, wherein the method further comprises the step: air-forming the cellulose blank structure onto the forming section. The forming section is controlling the forming of the cellulose blank structure onto the forming wire, and the forming section may be used for shaping the cellulose blank structure into suitable configurations.

In some example embodiments, which may be combined with any one or more of the above-described embodiments, the product forming unit comprises a blank recycling module, wherein the method further comprises the step: transporting residual parts of the cellulose blank structure from the pressing module to the blank dry-forming module.

In some example embodiments, which may be combined with any one or more of the above-described embodiments, the blank recycling module comprises a recycling compacting unit, wherein the method further comprises the step: compacting the residual parts of the cellulose blank structure in the recycling compacting unit upon transportation from the pressing module to the blank dry-forming module.

The present disclosure also relates to a cellulose product toggle pressing module for forming non-flat cellulose products from an air-formed cellulose blank structure. The toggle pressing module comprising: a toggle press including a pressing member movably arranged in a pressing direction, a toggle-mechanism drivingly connected to the pressing member, a pressing actuator arrangement drivingly connected to the toggle-mechanism for controlling motion of the toggle-mechanism between a retracted operating position and an extended operating position; a forming mold including a moveable first mold part attached to the pressing member and a second mold part; an adjustment mechanism for enabling adjustment of a distance between the first and second mold parts in the pressing direction while having the toggle-mechanism in a non-moving operating state, and an adjustment actuator arrangement configured for driving the adjustment mechanism; a pressing force indicating arrangement; and an electronic control system operatively connected to the pressing force indicating arrangement, the pressing actuator arrangement and the adjustment actuator arrangement; wherein the electronic control system is configured for controlling operation of pressing actuator arrangement for driving the pressing member in the pressing direction by setting the toggle-mechanism in the extended operating position, and thereby forming the non-flat cellulose product from the air-formed cellulose blank structure by pressing the first mold part against the second mold part, and wherein the electronic control system is configured for controlling operation of the adjustment actuator arrangement, based on pressing force indicating feedback information received from the pressing force indicating arrangement.

The various above-described aspects from the dependent claims may of course be combined also with this cellulose product toggle pressing module.

The present disclosure also relates to a method for forming non-flat cellulose products from an air-formed cellulose blank structure in a toggle pressing module, which comprises: a toggle press including a pressing member movably arranged in a pressing direction, a toggle-mechanism drivingly connected to the pressing member, a pressing actuator arrangement drivingly connected to the toggle-mechanism for controlling motion of the toggle-mechanism between a retracted operating position and an extended operating position; a forming mold including a moveable first mold part attached to the pressing member and a second mold part; an adjustment mechanism for enabling adjustment of a distance between the first and second mold parts in the pressing direction while having the toggle-mechanism in a non-moving operating state, and an adjustment actuator arrangement configured for driving the adjustment mechanism; a pressing force indicating arrangement; and an electronic control system operatively connected to the pressing force indicating arrangement, the pressing actuator arrangement and the adjustment actuator arrangement. The method comprises: air-forming a cellulose blank structure onto the forming wire by means of the blank dry-forming module; feeding the air-formed cellulose blank structure into a pressing area defined by the first and second, spaced apart, mold parts; controlling operation of the pressing actuator arrangement for performing pressing operations, which involves driving the pressing member in the pressing direction by setting the toggle-mechanism in the extended operating position, and thereby forming the non-flat cellulose product from the air-formed cellulose blank structure by pressing the first mold part against the second mold part; and controlling operation of the adjustment actuator arrangement, based on pressing force indicating feedback information received from the pressing force indicating arrangement.

The various above-described aspects from the dependent claims may of course be combined with this method for forming non-flat cellulose products.

Further features and advantages of the invention will become apparent when studying the appended claims and the following description. The skilled person in the art realizes that different features of the present disclosure may be combined to create embodiments other than those explicitly described hereinabove and below, without departing from the scope of the present disclosure.

### BRIEF DESCRIPTION OF DRAWINGS

The product forming unit and associated method for forming non-flat cellulose according to the disclosure will be described in detail in the following, with reference to the attached drawings, in which

FIG. 1a shows a schematic layout of the product forming unit according to the disclosure,

FIG. 1b shows schematically a perspective view of a product forming unit according to the disclosure,

FIG. 1c shows schematically, in a perspective view, a blank dry-forming module according to the disclosure,

FIG. 1d-e show schematically two example embodiments of the routing of the cellulose blank structure within the product forming unit according to the disclosure,

FIG. 2a-b show two timing diagrams reflecting alternative control strategies for operating the product forming unit according to the disclosure,

FIG. 3a shows schematically a perspective view of the pressing module according to the disclosure,

FIG. 3b-e show schematically side views of the cellulose forming process within the forming mold according to the disclosure,

FIG. 4a-b show schematically side views of the pressing module according to the disclosure,

FIG. 5 shows the main process steps of a pressing cycle,

FIG. 6a-b show schematically side views of alternative orientations of the pressing module according to the disclosure,

FIG. 7a-b show schematically side views of alternative designs of the toggle mechanism according to the disclosure,

FIG. 8a-c show schematically side views of alternative operative settings of the adjustment mechanism of the pressing module according to the disclosure,

FIG. 9 shows a pressing force curve,

FIG. 10a-b show schematically alternative control systems of the pressing module according to the disclosure,

FIG. 11 shows an alternative schematic layout of the product forming unit according to the disclosure,

FIG. 12a-b show schematically side views of the pressing module according to a further example embodiment of the disclosure, and

FIG. 13-14 show schematically some basic steps of various methods according to the disclosure.

### DETAILED DESCRIPTION OF DRAWINGS

Various aspects of the disclosure will hereinafter be described in conjunction with the appended drawings to illustrate and not to limit the disclosure, wherein like designations denote like elements, and variations of the described aspects are not restricted to the specifically shown embodiments, but are applicable on other variations of the disclosure.

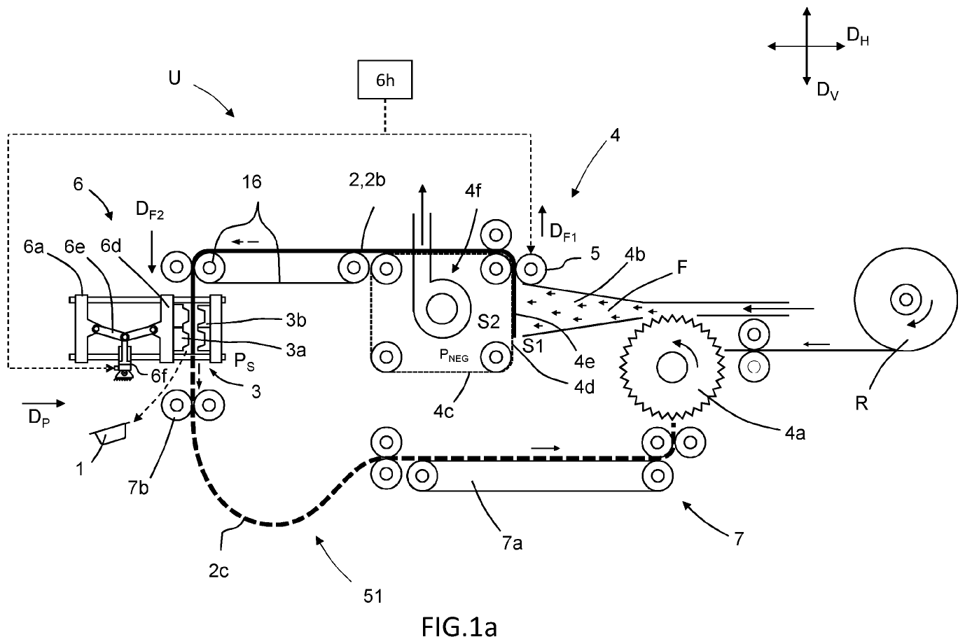

FIGS. 1a and 1b schematically show different schematic views of an example embodiment of a product forming unit U for manufacturing cellulose products 1 from an air-formed cellulose blank structure 2. FIG. 1a shows a schematic layout of the product forming unit U and FIG. 1b shows a perspective side-view of the product forming unit U. The product forming unit U has extensions in a horizontal direction or plane D_{H} and a vertical direction D_{V}. The product forming unit U comprises a blank dry-forming module 4 and a pressing module 6, as will be further described below.

The cellulose products 1 are formed from the cellulose blank structure 2 in the product forming unit U. The pressing module 6 comprises one or more forming molds 3 for forming the cellulose products 1 from the cellulose blank structure 2 in a pressing operation. The cellulose blank structure 2 is air-formed in the blank dry-forming module 4 onto a forming wire 4c, and fed to the one or more forming molds 3 of the pressing module 6. The forming of the cellulose products 1 is thus accomplished in the pressing module 6. The cellulose products 1 are non-flat. With non-flat products is meant products that have an extension in three dimensions, which is different from flat products like blanks or sheets.

With an air-formed cellulose blank structure 2 is meant an essentially air-formed fibrous web structure produced from cellulose fibers. The cellulose fibers may originate from a suitable cellulose raw material R, such as a pulp material. Suitable pulp materials are for example fluff pulp, paper structures, or other cellulose fiber containing structures. With air-forming of the cellulose blank structure 2 is meant the formation of a cellulose blank structure in a dry-forming process in which the cellulose fibers are air-formed to produce the cellulose blank structure 2. When air-forming the cellulose blank structure 2 in the air-forming process, the cellulose fibers are carried and formed to the fiber blank structure 2 by air as carrying medium. This is different from a normal papermaking process or a traditional wet-forming process, where water is used as carrying medium for the cellulose fibers when forming the paper or fiber structure.

In the air-forming process, small amounts of water or other substances may if desired be added to the cellulose fibers in order to change the properties of the cellulose product, but air is still used as carrying medium in the forming process. The cellulose blank structure 2 may, if suitable have a dryness that is mainly corresponding to the ambient humidity in the atmosphere surrounding the air-formed cellulose blank structure 2. As an alternative, the dryness of the cellulose blank structure 2 can be controlled in order to have a suitable dryness level when forming the cellulose products 1.

The blank dry-forming module 4 of the embodiment illustrated in FIGS. 1a and 1b, which is shown separately in FIG. 1c, has a horizontal distribution direction of the cellulose fibers F from the mill 4a to the forming wire 4c through the forming chamber 4b. A horizontal flow of air is thus feeding the cellulose fibers F from the mill 4a to the forming section 4d, which is different from traditional dry-forming systems with a vertical flow of air. The length of the fiber carrying distance by the flow of air inside the forming chamber 4b needs to be long enough to minimize turbulence and/or create a uniform flow of cellulose fibers F. Thus, the length of the blank forming module 4 is therefore dependent of the fiber carrying distance by the flow of air.

The upwards blank forming direction Du enables a compact configuration and layout of the product forming unit U, and is reducing the length of the product forming unit U compared to traditional solutions. Further, access for maintenance of the mill 4a from a plant floor level is enabled without additional elevated flooring structures or platforms, due to the positioning of the blank dry-forming unit 4 at the plant floor level. This positioning and the horizontal flow of air also enables low height of the product forming unit U compared to traditional solutions using vertical air flow.

The cellulose blank structure 2 may be air-formed in the dry-forming module 4 into discrete cellulose blanks. The discrete cellulose blanks are formed as discrete pieces of material that are separated from each other and may for example be shaped into suitable configurations to avoid residual material after forming, which is minimizing the amount of cellulose material used. Alternatively, the cellulose blank structure 2 may be air-formed in the dry-forming module 4 into a continuous cellulose blank 2b. Depending on the air-forming process, the basis weight of the air-formed cellulose blank structure 2 may be uniform or varying.

With reference to FIGS. 1a-1c, the blank dry-forming module 4 comprises a mill 4a, a forming chamber 4b, and a forming wire 4c arranged in connection to the forming chamber 4b. Fibers F from the cellulose raw material R is separated from the cellulose raw material R in the mill 4a and the separated fibers F are distributed into the forming chamber 4b onto the forming wire 4c for forming the cellulose blank structure 2. The mill 4a is configured for separating cellulose fibers F from the cellulose raw material R, and the forming chamber 4b is configured for distributing the separated fibers F onto a forming section 4d of the forming wire 4c for forming the cellulose blank structure 2. The forming section 4d is arranged in connection to a forming chamber opening 4e of the forming chamber 4b. In the illustrated embodiment, the forming section 4d is extending in an upwards blank forming direction Du. The cellulose blank structure 2 is formed onto the forming section 4d, and transported by the forming wire 4c from the forming section 4d in the upwards blank forming direction Du, and subsequently further towards the pressing module 6. The upwards blank forming direction Du is used for a compact configuration and layout of the product forming unit U, allowing an efficient positioning of the different modules of the product forming unit U in relation to each other.

The pulp structure 20 used may for example be bales, sheets, or rolls of fluff pulp, paper structures, or other suitable cellulose fiber containing structures, that are fed into the mill 4a. The mill 4a may be of any conventional type, such as for example a hammer mill, a saw-tooth mill, or other type of pulp de-fiberizing machine. The pulp structure 20 is fed into the mill 4a through an inlet opening, and the separated fibers F are distributed to the forming chamber 4b through an outlet opening of the mill 4a arranged in connection to the forming chamber 4b.

The forming chamber 4b is arranged for distributing the separated fibers onto the forming wire 4c for air-forming the cellulose blank structure 2. The forming chamber 4b is arranged as a hood structure or compartment in connection to the forming wire 4c. The forming chamber 4b is enclosing a volume in which the separated fibers F are distributed from the mill 4a to the forming wire 4c. The cellulose fibers F are distributed by a flow of air generated by the mill 4a, and the flow of air is transporting the fibers in the forming chamber 4b from the mill 4a to the forming wire 4c.

The forming wire 4c may be of any suitable conventional type, and may be formed as an endless belt structure, as illustrated in FIGS. 1a-b. A vacuum box 4f may be arranged in connection to the forming wire 4c and the forming chamber 4b for controlling the flow of air in the forming chamber 4b, and for distributing the separated fibers F onto the forming wire 4c. The forming wire 4c has a first side S1 facing the forming chamber 4b and a second side S2 facing the vacuum box 4f. The cellulose blank structure 2 is in this way air-formed onto the first side S1 of the forming wire 4c upon application of a negative pressure PNEG onto the second side S2 for securing attachment of the cellulose fibers F onto the first side S1.

The blank dry-forming module 4 is as illustrated in for example FIGS. 1a-1c is arranged upstream the pressing module 6. The pressing module 6 includes a toggle press 6a with a forming mold 3 mounted therein. The toggle press 6a operates with a reciprocating motion having two main phase: an open phase during which the cellulose blank structure 2 may be fed into the forming mold, and a pressing phase during which the cellulose blank structure 2 within the forming mold is non-moving. Consequently, the cellulose blank structure 2 needs to be intermittently transported to the forming mold 3 of the pressing module 6.

Intermittent feeding of the cellulose blank structure 2 to the forming mold 3 of the pressing module 6 is, according to the present disclosure, is solved by operating also the forming wire 4a of the blank dry-forming module 4 intermittently and in a synchronized manner with pressing module 6.

In the example embodiment of FIG. 1a, the product forming unit U additionally includes an intermediate feeding device 16 arranged between the blank dry-forming module 4 and pressing module 6. The intermediate transport or feeding device 16, which may be a conveyer belt and/or a set of feeding rollers or the like, may then also be arranged to operate intermittently and in a synchronized manner with pressing module 6.

In other words, the product forming unit U may further comprise a cellulose blank transport device 16, in particular a conveyer belt, a set of feeding rollers, vacuum belts, elongated tractor belt feeders, or the like, configured for transporting the air-formed cellulose blank structure 2 from forming wire 4c of the blank dry-forming module 4 to the forming mold 3 of the toggle pressing module 6, wherein the electronic control system 6h is configured for providing substantially synchronized operation of the forming wire 4c and transport device. Thereby, the forming wire 4c and transport device are substantially always operating with the same transport speed.

Consequently, the intermittent transporting of the cellulose blank structure 2 to the pressing module 6 is in the example embodiment of FIG. 1a arranged partly with the forming wire 4a and partly with a suitable feeding device 16 that is intermittently controlled to feed the cellulose blank structure 2 to the pressing module 6. When the pressing module 6 is operated to apply the forming pressure P_{F} onto the cellulose blank structure 2, the cellulose blank structure 2 is in a non-moving state, or at least in a state of low operating speed.

In other words, the feeding of the cellulose blank structure 2 to the forming position between the one or more first mold parts 3a and the one or more second mold parts 3b is taking place when the mold parts are in an open state, thereby allowing the cellulose blank structure 2 to be securely positioned between the one or more first mold parts 3a and the one or more second mold parts 3b without any disturbing interaction from the mold parts.

Consequently, the present disclosure relates to a product forming unit U for manufacturing non-flat cellulose products 1 from an air-formed cellulose blank structure 2, wherein the product forming unit U comprises a blank dry-forming module 4 with a moveable forming wire 4c, a toggle pressing module 6 with a toggle press 6a and a forming mold 3, and an electronic control system 6h operatively connected to the forming wire 4c and the toggle press 6a. The blank dry-forming module 4 is configured for air-forming the cellulose blank structure 2 onto the forming wire 4c. Furthermore, the toggle press 6a includes a pressing member 6d movably arranged in a pressing direction D_{P}, a toggle-mechanism 6e drivingly connected to the pressing member 6d, and a pressing actuator arrangement 6f drivingly connected to the toggle-mechanism 6e. In addition, the forming mold 3 includes a moveable first mold part 3a attached to the pressing member 6d and a second mold part 3b. The electronic control system 6h is configured for controlling operation of the pressing actuator arrangement 6f for performing pressing operations, which involves driving the pressing member 6d in the pressing direction D_{P} by means of the toggle-mechanism 6e, and thereby forming the non-flat cellulose product from the air-formed cellulose blank structure by pressing the first mold part 3a against the second mold part 3b. Moreover, the electronic control system 6h further is configured for intermittently feeding the forming wire 4c between subsequent pressing operations.

The moveable forming wire 4c is for example an air-permeable conveyer belt.

The air-formed cellulose blank structure 2 is for example an air-formed fibrous web structure produced from cellulose fibers.

In the example embodiment of FIG. 1a, the electronic control system 6h is operatively connected to a driving motor 5 of forming wire 4c and to a pressing actuator arrangement 6f of the toggle press 6a.

After the pressing operation, the electronic control system 6h is configured for controlling operation of the pressing actuator arrangement 6f for driving the pressing member 6d in a direction opposite to the pressing direction D_{P} for opening the forming mold 3.

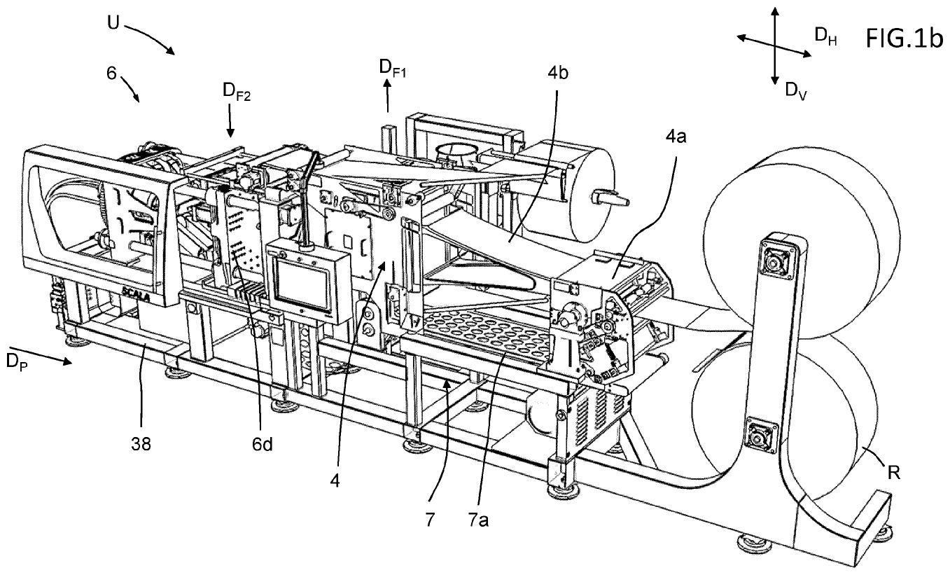

A first example embodiment for operating the product forming unit U is described more in detail with respect to FIG. 2a, which shows a timing diagram of short operating sequence of the product forming unit U, including the operating speed V_{W} of the forming wire 4c over time (solid line), as well as the operating speed V_{P} of the pressing member over time (dashed line).

During a first time period t1, the forming mold 3 is in the opened state, and the forming wire 4c is temporarily activated for feeding a new section of the cellulose blank structure 2 into the forming mold 3. During the first time period t1, the operating speed V_{W} of the forming wire 4c goes from zero to a predetermined target speed V1, and subsequently back to zero speed. There is no buffer device or the like located between the forming wire 4c and the forming mold 3, so the cellulose blank structure 2 may here be deemed having the same feeding speed into the forming mold as the operating speed V_{W} of the forming wire 4c.

During a second time period t2, which in the illustrated example embodiments follows the first time period t1 except for a small overlap with the ending of first time period t1, the pressing member 6d is controlled to move forwards for closing to the forming mold 3, and to start a fiber forming event. During the second time period t2, the operating speed V_{P} of the pressing member 6d goes from zero to a predetermined target speed, and subsequently back to zero speed. The operating speed V_{W} of the forming wire 4c is zero during at least the end region of the second time period t2 for avoiding supply of cellulose blank structure 2 towards a closed forming mold 3.

During a subsequent third time period t3, which follows the second time period t2, both the forming wire 4c and the pressing member 6d are controlled to temporarily hold the operating position, i.e. to remain in a non-moving state. During the third time period, the forming mold 3 is closed and the toggle press 6a applies full compression force on the forming mold. In other words, the third time period t3 corresponds to a fiber forming event of the cellulose blank structure 2 located in the forming mold 3.

During a fourth time period t4, which follows the third time period t3, the pressing member 6d is controlled to move rearwards for opening the forming mold 3. During the fourth time period t4, the operating speed V_{P} of the pressing member 4c goes from zero to a predetermined target speed, and subsequently back to zero speed. The return speed is here illustrated as being negative for indicating the motion direction of the pressing member 6d, namely retraction.

At an end region of the fourth time period t4, or thereafter, the operating speed V_{W} of the forming wire 4c goes from zero to a predetermined target speed again, thereby repeating the periodic sequence t5. The total time period t5 composed of the accumulated time periods t1-t4 thus represent a repeating periodic operating sequence of the product forming unit U.

The timing diagram of FIG. 2a clearly shows the that electronic control system 6h is configured for intermittently feeding the forming wire 4c, because the operating speed V_{W} of the forming wire 4c is clearly not constant but rather periodically changing over a total time period 5.

Furthermore, the timing diagram of FIG. 2a clearly shows the that electronic control system 6h is configured for feeding the forming wire 4c between subsequent pressing operations, i.e. before and after the third time period t3.

FIG. 2a shows that the electronic control system 6h is configured for intermittently feeding the forming wire 4c between subsequent pressing operations, such that the forming wire 4c is operated periodically with a relatively high speed V1 during time periods t1 between subsequent pressing operations t3, and with zero speed during time periods t3 coinciding with pressing operations.

A second example embodiment for operating the product forming unit U is described more in detail with respect to FIG. 2b, which shows a timing diagram of short operating sequence of the product forming unit U, including the operating speed V_{W} of the forming wire 4c over time (solid line), as well as the operating speed V_{P} of the pressing member over time (dashed line).

In this example embodiment, the operating sequence and operating speed V_{P} of the pressing member 6d is substantially equal to that described above with reference to FIG. 2a. However, this example embodiment shows that the forming wire 4c may be controlled to have a certain operating speed V_{W} during time periods t3 coinciding with pressing operations. This may in certain applications be deemed advantageous, for example because it provides a smoother and less variations in thickness of the resulting cellulose blank structure 2. On the other hand, such operating control of the forming wire 4c generally requires a certain level of buffering of the cellulose blank structure 2 during transportation from the blank dry-forming module 4 to the toggle pressing module 6.

The operating speed V_{W} of the forming wire 4c may be relatively low during said time periods t3 coinciding with pressing operations. In fact, the operating speed V_{W} of the forming wire 4c may even be partly zero and partly above zero during time periods t3 coinciding with pressing operations. Consequently, the buffering requirements may be held relatively low, and implemented for example by means of a variable length hanging section of the cellulose blank structure 2, or variable length curved section of the cellulose blank structure 2, or some type of relatively small capacity buffering equipment.

With reference to FIG. 2b, during a first time period t1, the forming mold 3 is in the opened state, and the forming wire 4c is controlled for feeding a new section of the cellulose blank structure 2 into the forming mold 3. During the first time period t1, the operating speed V_{W} of the forming wire 4c goes from a relatively low speed V2 to a predetermined, relatively high, target speed V1, and subsequently back to relatively low speed V2. The relatively low speed V2 may for example be about 1-30% of the relatively high speed V1.

During a second time period t2, which in the illustrated example embodiments follows the first time period t1 except for a small overlap with the ending of first time period t1, the pressing member 6d is controlled to move forwards for closing to the forming mold 3, and to start a fiber forming event. During the second time period t2, the operating speed V_{P} of the pressing member 6d goes from zero to a predetermined target speed, and subsequently back to zero speed. The operating speed V_{W} of the forming wire 4c remains in this example embodiment at the relatively low speed V1. As soon as the forming mold 3 becomes closed the cellulose blank structure 2 starts accumulating in the buffer.

During a subsequent third time period t3, which follows the second time period t2, both the forming wire 4c and the pressing member 6d are controlled to temporarily hold the operating position, i.e. to remain in a non-moving state. This corresponds thus to fiber forming event of the cellulose blank structure 2 located in the forming mold 3.

During a fourth time period t4, which follows the third time period t3, the pressing member 6d is controlled to move rearwards for opening the forming mold 3. During the fourth time period t4, the operating speed V_{P} of the pressing member 4c goes from zero to a predetermined target speed, and subsequently back to zero speed. The return speed is here illustrated as being negative for indicating the motion direction of the pressing member 6d, namely retraction.

As soon as the forming mold 3 opens, the cellulose blank structure 2 in the buffer may be supplied to the forming mold 3.

At the end of the fourth time period t4, the operating sequence starts over again with time period t1.

The timing diagram of FIG. 2b clearly shows the that electronic control system 6h may be configured for intermittently feeding the forming wire 4c, because the operating speed V_{W} of the forming wire 4c is clearly not constant but rather periodically changing over a total time period t5.

Furthermore, the timing diagram of FIG. 2b clearly shows the that electronic control system 6h is configured for feeding the forming wire 4c between subsequent pressing operations, i.e. before and after the third time period t3.

In addition, FIG. 2b shows that the electronic control system 6h may be configured for intermittently feeding the forming wire 4c between subsequent pressing operations, such that the forming wire 4c is operated periodically with a relatively high speed V1 during time periods t1 between subsequent pressing operations t3, and with a relatively low speed, during time periods t3 coinciding with pressing operations.

In other words, the driving motor 5 of the forming wire 4c is operated to according to a periodic sequence, which includes a first time period of relatively high speed followed by a second time period of relatively low speed or zero speed.

Consequently, according to some example embodiments, the electronic control system 6h is configured for synchronized operation of the forming wire 4c and the toggle press 6a, such that the forming wire 4c is operated, or operated with a relatively high speed, during time periods when the toggle press 6a is a non-pressing state, and such that the forming wire 4c is in stillstand state, or operating with a relatively low speed V2, during time periods when the toggle press 6a is in a pressing state.

Others said, the electronic control system 6h may be configured for controlling operation of forming wire 4c and the toggle press 6a, such that the feeding speed of the forming wire, in particular over a complete pressing cycle t5, is equal to, or at least substantially equal to, the feeding speed of the air-formed cellulose blank structure 2 entering the forming mold 3.

Furthermore, the product forming unit U may be free from a buffering module arranged between the blank dry-forming module 4 and the toggle pressing module 6. This concerns in particular the product forming unit U described with reference to FIG. 2a.

Since the forming unit U may be arranged without any buffering modules or similar arrangements, or at least arranged with only relatively small buffering capacity, the intermittent transportation of the cellulose blank structure to the pressing module needs to be synchronized with the air-forming of the cellulose blank structure 2 in the blank dry-forming module 4.

It should be understood that a forming pressure may be applied to the cellulose blank structure 2 in only one pressing step during the pressing operation, as described above with reference to FIGS. 2a-2b. Alternatively, a forming pressure may be applied in two or more repeated pressing steps during the pressing operation, and in this way the mold parts are repeatedly exerting a forming pressure onto the cellulose blank structure.

Suitably, the pressing operation is a single pressing operation, in which a forming pressure is applied to the cellulose blank structure 2 in only one pressing step during the pressing operation. With the single pressing operation is thus meant that the cellulose product 1 is formed from the cellulose blank structure 2 in one single pressing step in the pressing module 6. In the single pressing operation, the one or more first mold parts 3a and the one or more second mold parts 3b are interacting with each other for establishing a forming pressure and the forming temperature during a single operational engagement step. In the single pressing operation, a forming pressure and a forming temperature are not applied to the cellulose blank structure 2 in two or more repeated or subsequent pressing operations.

As described above, the product forming unit U therefore includes an electronic control system 6h arranged for controlling operation of both a blank dry-forming module 4 and the toggle pressing module 6, and in particular for controlling operation of one or more driving motors used for driving the forming wire 4c of a blank dry-forming module 4, and for controlling operation of a pressing actuator arrangement 6f used for driving the toggle pressing module 6.

The mill 4a may be operated in different ways depending on the configuration of the cellulose blank structure 2 that is being air-formed in the blank dry-forming module 4. The mill 4a is suitably continuously operated. In one embodiment, the cellulose raw material R is continuously fed to the mill 4a. In alternative embodiments, the cellulose raw material R is instead intermittently fed to the mill 4a.

The air-formed cellulose blank structure 2 may be formed of cellulose fibers in a conventional air-forming process or in a blank dry-forming module 4 as illustrated in FIGS. 1a-b, and be configured in different ways. For example, the cellulose blank structure 2 may have a composition where the fibers are of the same origin or alternatively contain a mix of two or more types of cellulose fibers, depending on the desired properties of the cellulose products 1. The cellulose fibers used in the cellulose blank structure 2 are during the forming process of the cellulose products 1 strongly bonded to each other with hydrogen bonds. The cellulose fibers may be mixed with other substances or compounds to a certain amount as will be further described below. With cellulose fibers is meant any type of cellulose fibers, such as natural cellulose fibers or manufactured cellulose fibers. The cellulose blank structure 2 may specifically comprise at least 95% cellulose fibers, or more specifically at least 99% cellulose fibers.

The air-formed cellulose blank structure 2 may have a single-layer or a multi-layer configuration. A cellulose blank structure 2 having a single-layer configuration is referring to a structure that is formed of one layer containing cellulose fibers. A cellulose blank structure 2 having a multi-layer configuration is referring to a structure that is formed of two or more layers comprising cellulose fibers, where the layers may have the same or different compositions or configurations.

The cellulose blank structure 2 may comprise a reinforcement layer comprising cellulose fibers, where the reinforcement layer may be arranged as a carrying layer for one or more other layers of the cellulose blank structure 2. The reinforcement layer may have a higher tensile strength than other layers of the cellulose blank structure 2. This is useful when one or more air-formed layers of the cellulose blank structure 2 have compositions with low tensile strength in order to avoid that the cellulose blank structure 2 will break during the forming of the cellulose products 1. The reinforcement layer with a higher tensile strength acts in this way as a supporting structure for other layers of the cellulose blank structure 2. The reinforcement layer may be of a different composition than the rest of the cellulose blank structure, such as for example a tissue layer containing cellulose fibers, an air laid structure comprising cellulose fibers, or other suitable layer structures. It is thus not necessary that the reinforcement layer is air-formed. The cellulose blank structure 2 may comprise more than one reinforcement layer if suitable.

The cellulose blank structure 2 may further comprise or be arranged in connection to one or more barrier layers giving the cellulose products the ability to hold or withstand liquids, such as for example when the cellulose products 1 are used in contact with beverages, food, and other water-containing substances. The one or more barrier layers may be of a different composition than the rest of the cellulose blank structure 2, such as for example a tissue barrier structure.

The one or more air-formed layers of the cellulose blank structure 2 are fluffy and airy structures, where the cellulose fibers forming the structures are arranged relatively loosely in relation to each other. The fluffy cellulose blank structures 2 are used for an efficient forming of the cellulose products 1, allowing the cellulose fibers to form the cellulose products 1 in an efficient way during the forming process.

The product forming unit U may further comprise a barrier application module arranged upstream the pressing module 6. The barrier application module is configured for applying a barrier composition onto the cellulose blank structure 2 before forming the cellulose products 1 in one or more forming molds 3.

One preferred property of the cellulose products 1 is the ability to hold or withstand liquids, such as for example when the cellulose products are used in contact with beverages, food, and other water-containing substances. The barrier composition may be one or more additives used when producing the cellulose products, such as for example AKD or latex, or other suitable barrier compositions. Another suitable barrier composition is a combination of AKD and latex, where tests have shown that unique product properties may be achieved with a combination of AKD and latex added to the air-formed cellulose blank structure 2 when forming the cellulose products 1. When using the combination of AKD and latex, a high level of hydrophobicity can be achieved, resulting in cellulose products 1 with a high ability to withstand liquids, such as water, without negatively affecting the mechanical properties of the cellulose products 1.

The barrier application module may be arranged as a hood structure in connection to the cellulose blank structure 2, and the hood structure is comprising spray nozzles that are spraying the barrier composition continuously or intermittently onto the cellulose blank structure 2. In this way, the barrier composition is applied onto the cellulose blank structure 2 in the barrier application module. The barrier composition may be applied on only one side of the cellulose blank structure or alternatively on both sides. The barrier composition may further be applied over the whole surface or surfaces of the cellulose blank structure 2, or only on parts or zones of the surface or surfaces of the cellulose blank structure 2. The hood structure of the barrier application module is preventing the barrier composition from being spread into the surrounding environment. Other application technologies for applying the barrier structure may for example include slot coating and/or screen-printing.

The product forming unit U is further adapted for forming the non-flat cellulose products 1 from the cellulose blank structure 2 in the one or more forming molds 3 by heating the cellulose blank structure 2 to the forming temperature T_{F}, and pressing the cellulose blank structure 2 with the forming pressure. The one or more forming molds 3 are configured for forming the non-flat cellulose products 1 from the cellulose blank structure 2 by heating the cellulose blank structure 2 to the forming temperature T_{F} in the range of 100-300° C., and pressing the cellulose blank structure 2 with a forming pressure in the range of 1-100 MPa, preferably 4-20 MPa.

The differing first feeding direction D_{F1} and second feeding direction D_{F2} are allowing a compact configuration and layout of the product forming unit U, and an efficient and compact positioning of the different modules of the product forming unit U in relation to each other.

The product forming unit is adapted for intermittently feeding the cellulose blank structure from the blank dry-forming module by the forming wire in a first feeding direction, and for intermittently feeding the cellulose blank structure to the pressing module in a second feeding direction, where the second feeding direction D_{F2} differs from the first feeding direction D_{F1}. The differing first feeding direction D_{F1} and second feeding direction D_{F2} are allowing a compact configuration and layout of the product forming unit U, and an efficient and compact positioning of the different modules of the product forming unit U in relation to each other.

In some example embodiments, the second feeding direction D_{F2} is opposite to, or essentially opposite to, the first feeding direction D_{F1}.

Having the second feeding direction D_{F2} arranged essentially opposite to the first feeding direction D_{F1} means that the second feeding direction D_{F2} differs less than 45 degrees, specifically less than 30 degrees, from the opposite direction to the first feeding direction D_{F1}.

In the illustrated embodiments, the first feeding direction D_{F1} is an upwards direction and the second feeding direction D_{F2} is a downwards direction, which is allowing a compact and efficient configuration of the product forming unit U.

The feeding route and feeding direction of the cellulose blank structure 2 of the example embodiment of FIGS. 1a-b is for clarification purpose schematically illustrated in FIG. 1d, and the compact configuration and layout of the product forming unit U enabled by routing the cellulose blank structure 2 first primarily upwards, then primarily horizontal and subsequently primarily downwards is clearly understandable, when compared with a conventional straight line horizontal routing of a cellulose product compression forming process.

Alternatively, the blank dry-forming module 4 may be arranged to have a primarily horizontal orientation of the feeding route and feeding direction of the cellulose blank structure 2, i.e. to have a primarily horizontal orientation of the forming wire 4c in the area of the forming chamber opening 4e, as schematically illustrated in FIG. 1e, before routing the cellulose blank structure 2 upwards, then primarily horizontal and subsequently primarily downwards to the pressing module 6. This layout of the product forming unit U may also be used for providing a compact product forming unit U.

With reference to FIGS. 1d-e, the blank dry-forming module 4 typically forms the start of the feeding route and the pressing module 6 typically forms the end of the feeding route, when not taking a blank recycling module 7 into account. Other modules, such as the barrier application module are located at any suitable positions between the dry-forming module 4 and the pressing module 6, i.e. downstream of the dry-forming module 4 and upstream of the pressing module 6, and not necessarily at the example positions of the embodiment of FIGS. 1a-b.

The primarily downwards routing of the cellulose blank structure while passing the pressing module 6 is beneficial in terms of simplified feeding of the cellulose blank structure 2, as well as simplified cellulose products 1 plundering after completed forming process, i.e. upon leaving the pressing module 6.

Specifically, high-speed intermittent feeding of the cellulose blank structure 2 from the dry-forming module 4 to the pressing module 6 may be difficult to accomplish with damaging or altering a characteristics of the cellulose blank structure 2, such as the thickness of the cellulose blank structure 2, or the like. However, by arranging the toggle press in a primarily horizontal direction D_{H} and feeding the cellulose blank structure primarily downwards to the pressing module 6, the gravitational force assist this feeding process, thereby requiring less force to be applied by a feeding device 16 for feeding the air-formed cellulose blank structure 2 into a pressing area 15 of the pressing module 6, and thereby reducing the risk for damages and/or altered characteristics of the cellulose blank structure 2.

Moreover, plundering of the finished and ejected cellulose products 1 after completed forming process may also be simplified by means of the primarily vertical routing of the cellulose blank structure 2 through the forming mold 3, because the gravitational force may also here assist and simplify removal of the finished and ejected cellulose products 1 from the forming mold 3, and subsequent transportation to a storage chamber or conveyer belt, or the like.

The pressing module 6 comprises one or more forming molds 3, as indicated in FIGS. 1a-b and 3a, and each forming mold 3 comprises a first mold part 3a and a second mold part 3b. Corresponding first and second mold parts are cooperating with each other during the forming of the non-flat cellulose products 1 in the pressing module 6. Each first mold part 3a and corresponding second mold part 3b are movably arranged in relation to each other, and the first mold part 3a and the second mold part 3b are configured for moving in relation to each other in a pressing direction D_{P}.

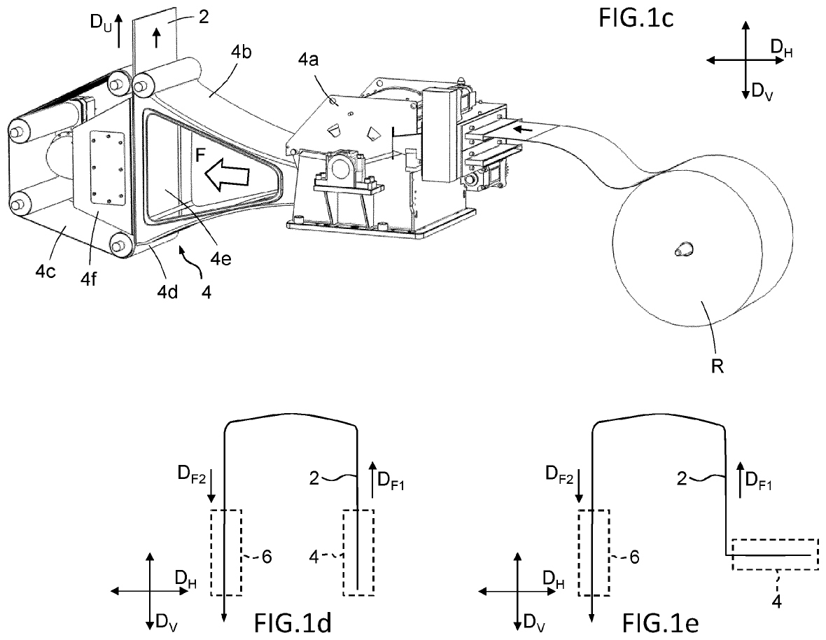

In the embodiments illustrated in FIGS. 1a-b and 3a-e, the second mold part 3b is stationary and the first mold part 3a is movably arranged in relation to the second mold part 3b in the pressing direction D_{P}, and back. As indicated with the double arrow in FIG. 3b, the first mold part 3a is configured to move both towards the second mold part 3b and away from the second mold part 3b in linear movements along an axis extending in the pressing direction D_{P}.

In alternative embodiments, the first mold part 3a may be stationary with the second mold part 3b movably arranged in relation to the first mold part 3a, or both the first mold part 3a and the second mold part 3b may be movably arranged in relation to each other.

The pressing module 6 may be of a single-cavity configuration or alternatively of a multi-cavity configuration. A single-cavity pressing module comprises only one forming mold 3 with first and second mold parts. A multi-cavity pressing module comprises two or more forming molds 3, each having cooperating first and second mold parts. In the embodiment illustrated in FIGS. 1a-b and 3a, the pressing module 6 is arranged as a multi-cavity pressing module comprising a plurality of forming molds 3 with first and second mold parts, where the movements of the mold parts suitably are synchronized for a simultaneous forming operation. The part of the pressing module 6 shown in FIGS. 3b-e is illustrating the single-cavity configuration, or alternatively a section of the multi-cavity configuration with one forming mold 3. In the following, the pressing module 6 will be described in connection to a multi-cavity pressing module, but the disclosure is equally applicable on a single-cavity pressing module.

It should be understood that for all embodiments according to the disclosure, the expression moving in the pressing direction D_{P} includes a movement in the pressing direction D_{P}, and the movement may take place in opposite directions. The expression may further include both linear and non-linear movements of a mold part, where the result of the movement during forming is a repositioning of the mold part in the pressing direction D_{P}.

To form the non-flat cellulose products 1 from the air-formed cellulose blank structure 2 in the product forming unit U, the cellulose blank structure 2 is first provided from a suitable source. The cellulose blank structure 2 may be air-formed from cellulose fibers and arranged on rolls or in stacks. The rolls or stacks may thereafter be arranged in connection to the forming mold system S. As an alternative, the cellulose blank structure 2 may be air-formed from cellulose fibers in the blank dry-forming module 4 of the product forming unit U and directly fed to the pressing module 6.

The cellulose products 1 are formed from the cellulose blank structure 2 in the one or more forming molds 3 by heating the cellulose blank structure 2 to a forming temperature T_{F} in the range of 100-300° C., and pressing the cellulose blank structure 2 with a forming pressure in the range of 1-100 MPa, preferably 4-20 MPa. The first mold part 3a is arranged for forming the non-flat cellulose products 1 through interaction with the corresponding second mold parts 3b, as exemplified in FIGS. 3b-e. During forming of the cellulose products 1, the cellulose blank structure 2 is in each forming mold 3 exerted to the forming pressure in the range of 1-100 MPa, preferably in the range of 4-20 MPa, and the forming temperature T_{F} in the range of 100-300° C. The cellulose products 1 are thus formed from the cellulose blank structure 2 between each of the first mold part 3a and corresponding second mold part 3b by heating the cellulose blank structure 2 to the forming temperature T_{F} in the range of 100-300° C., and by pressing the cellulose blank structure 2 with the forming pressure in the range of 1-100 MPa, preferably in the range of 4-20 MPa. When forming the cellulose products 1, strong hydrogen bonds are formed between the cellulose fibers in the cellulose blank structure 2 arranged between the first mold part 3a and the second mold part 3b. The temperature and pressure levels are for example measured in the cellulose blank structure 2 during the forming process with suitable sensors arranged in or in connection to the cellulose fibers in the cellulose blank structure 2.

The pressing module 6 may further comprise a heating unit. The heating unit is configured for applying the forming temperature T_{F} onto the cellulose blank structure 2 in each forming mold 3. The heating unit may have any suitable configuration. The heating unit may be integrated in or cast into the first mold part 3a and/or the second mold part 3b, and suitable heating devices are e.g. electrical heaters, such as a resistor element, or fluid heaters. Other suitable heat sources may also be used.

When the cellulose blank structure 2 is arranged in a forming position between the first mold part 3a and the second mold part 3b, as shown in FIG. 3b, the first mold part 3a is moved towards the second mold part 3b in the pressing direction D_{P}, as illustrated with the arrow in FIG. 3c. Upon movement of the first mold part 3a towards the second mold part 3b, the cellulose blank structure 2 is being increasingly compacted between the pressing surface 3c, 3d of the mold parts, until the first mold part 3a have been further moved towards the second mold part 3b and reached a product forming position, as shown in FIG. 3d, in which the forming pressure and forming temperature T_{F} is exerted onto the cellulose blank structure 2. A forming cavity C for forming the cellulose products 1 is formed between each first mold part 3a and second mold part 3b during forming of the cellulose products 1 when each first mold part 3a is pressed towards its corresponding second mold part 3b with the cellulose blank structure 2 arranged between the mold parts. The forming pressure and the forming temperature T_{F} are applied to the cellulose blank structure 2 in each forming cavity C.

The forming of the cellulose products 1 may further include an edge-forming operation and a cutting or separation operation in the pressing module 6, where edges are formed on the cellulose products 1 and where the cellulose products 1 are separated from the cellulose blank structure 2 during forming of the cellulose products 1. The mold parts may for example be arranged with edge-forming devices and cutting or separation devices for such operations, or alternatively the edges may be formed in the product cutting or separation operation. Once the cellulose products 1 have been formed in the forming mold system S, the first mold part 3a is moved in a direction away from the second mold part 3b, as shown in FIG. 3e, and the cellulose products 1 can be removed from the pressing module 6, for example by using ejector rods or similar devices.

A deformation element E for establishing the forming pressure may be arranged in connection to each first mold part 3a and/or second mold part 3b. In the embodiment illustrated in FIGS. 3b-e, the deformation element E is attached to the first mold part 3a. By using a deformation element E, the forming pressure may be configured as an isostatic forming pressure.

The first mold part 3a and/or the second mold part 3b may comprise the deformation elements E, and the deformation elements E are configured for exerting the forming pressure on the cellulose blank structure 2 in the forming cavities C during forming of the cellulose products 1. The deformation elements E may be attached to the first mold part 3a and/or the second mold part 3b with suitable attachment means, such as for example glue or mechanical fastening members. During the forming of the cellulose products 1, the deformation elements E are deformed to exert the forming pressure on the cellulose blank structure 2 in the forming cavities C and through deformation of the deformation elements E, an even pressure distribution is achieved even if the cellulose products 1 are having complex three-dimensional shapes or if the cellulose blank structure 2 is having a varied thickness. To exert a required forming pressure on the cellulose blank structure 2, the deformation elements E are made of a material that can be deformed when a force or pressure is applied, and the deformation elements E are suitably made of an elastic material capable of recovering size and shape after deformation. The deformation elements E may further be made of a material with suitable properties that is withstanding the high forming pressure and forming temperature T_{F} levels used when forming the cellulose products 1.

Certain elastic or deformable materials have fluid-like properties when being exposed to high pressure levels. If the deformation elements E are made of such a material, an even pressure distribution can be achieved in the forming process, where the pressure exerted on the cellulose blank structure 2 in the forming cavity C from the deformation elements E is equal or essentially equal in all directions between the mold parts. When each deformation element E under pressure is in its fluid-like state, a uniform fluid-like pressure distribution is achieved. The forming pressure is with such a material thus applied to the cellulose blank structure 2 from all directions, and the deformation element E is in this way during the forming of the cellulose products 1 exerting an isostatic forming pressure on the cellulose blank structure 2. Each deformation element E may be made of a suitable structure of elastomeric material or materials, and as an example, the deformation element E may be made of a massive structure or an essentially massive structure of gel materials, silicone rubber, polyurethane, polychloroprene, or rubber with a hardness in the range 20-90 Shore A.

Further, in the embodiment illustrated in FIGS. 1a-b, the product forming unit U comprises a blank recycling module 7 for recycling cellulose fibers. The blank recycling module 7 is configured for feeding residual parts 2c of the cellulose blank structure 2 after forming of the cellulose products 1, from the pressing module 6 back to the blank dry-forming module 4. The blank recycling module 7 is arranged for transporting residual cellulose blank fiber material from the pressing module 6 to the mill 4a. After forming of the cellulose products 1 in the forming molds 3, there may be residual parts 2c of the cellulose blank structure containing cellulose blank fiber material. With the blank recycling module 7, the residual or remaining cellulose fibers can be recycled and re-used for forming a new cellulose blank structure 2 together with fibers from the cellulose raw material. In FIGS. 1a-b, an example embodiment of a blank recycling module 7 is schematically illustrated. The blank recycling module 7 comprises a feeding structure 7a, such as feeding belts, a conveyer structure, or other suitable means for transporting the residual parts 2c from the forming molds 3 to the mill 4a. The mill 4a may be arranged with a separate inlet opening for the residual material, where the residual parts 2c of the cellulose blank structure 2 are fed into the mill 4a.

The blank recycling module 7 may comprise a recycling compacting unit 7b. The recycling compacting unit 7b is compacting the residual parts 2c of the cellulose blank structure 2 upon transportation from the pressing module 6 to the blank dry-forming module 4. Suitably, the recycling compacting unit 7b is arranged as a pair of cooperating rollers that are compacting the residual parts 2c of the cellulose blank structure 2, as shown in FIG. 1a.

In a non-illustrated embodiment, the blank recycling module 7 may instead comprise a channel structure with an inlet portion arranged in connection to the forming molds 3, and the residual parts 2c of the cellulose blank structure can be sucked into the inlet portion for further transportation to the mill 4a. The channel structure may further be arranged with a suitable combined mill and fan unit, which is used for at least partly separate the residual material before further transportation to an outlet portion in connection to the mill 4a.

The blank recycling module 7 may further comprise a buffering arrangement 51 that has the purpose of converting the intermittent feeding motion of the residual parts 2c exiting the pressing module 6a to continuous feeding motion before supplying the residual parts 2c to the mill 4a. This is particularly relevant when the residual parts 2c has the form a continuous web structure. Continuous feeding of residual parts 2c to the mill 4a may be advantageous in terms of a more equal supply rate of residual parts 2c, and thus formation of a more equally thick cellulose blank structure 2 in the forming wire 4c. However, due to the intermittent operation of the pressing module 6, the intermittent supply of residual parts 2c from the pressing module 6a need to be converted to continuous feeding without breaking the web structure of the residual parts 2c. To achieve this, the buffering arrangement 51 may comprise a residual parts 2c feeding system configured for intermittently feeding the residual parts 2c to the buffering arrangement 51, and continuously feeding the residual parts 2c from the buffering module 5.

The buffering arrangement 5 may be implemented in form of hanging section of the continuous structure forming the residual parts 2c. In the hanging section, the residual parts 2c lacks vertical support from a conveyer belt, or the like, and may thus hang freely, wherein the buffering effect is accomplished by letting the residual parts 2c hang more or less deep in the hanging section. The buffering arrangement 5 may alternatively be implemented in form of a mechanical device having one or more moving parts controlled by an actuator.

With the modules described above, a compact construction of the product forming unit U is enabled, and the modules may be integrated into one single product forming unit U that is possible to ship in a freight container, and placed on a converter's plant floor in a simple manner. The differing feeding directions enable a more compact layout and construction of the product forming unit U.

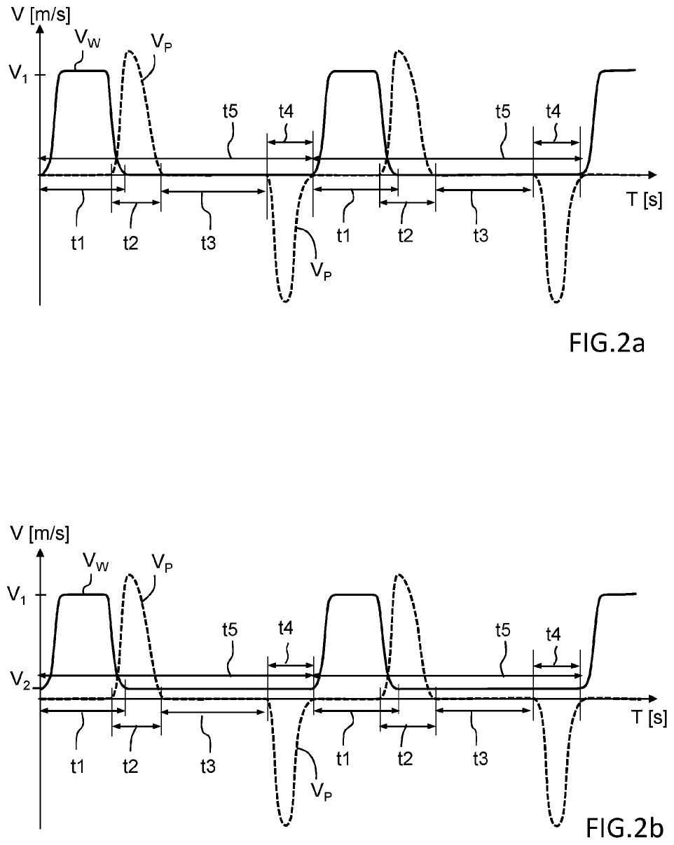

Some example embodiments of the pressing module 6 are described more in detail below with reference to the schematic drawings in FIGS. 3a and 4a-b, wherein FIG. 4a shows the toggle press 6a in an open state, and FIG. 4b shows the same toggle press 6a during a pressing action.

The cellulose product toggle pressing module 6 is particularly suitable for forming non-flat cellulose products 1 from an air-formed continuous cellulose blank structure 2, because a continuous cellulose blank structure 2 enables simplified handling and feeding of the blank structure 2 to the toggle press 6a, as well as simplified feeding of residual parts 2c of the cellulose blank structure 2 to the blank recycling module 7. However, the cellulose product toggle pressing module 6 is also suitable for forming non-flat cellulose products 1 from an air-formed non-continuous cellulose blank structure 2, such as individual sheet pieces of air-formed cellulose blank structures 2.

The pressing actuator arrangement 6f may for example include a single or a plurality of hydraulic or pneumatic linear actuators, such as cylinder-piston actuators. Alternatively, a motor with a rotating output shaft, such as an electric, hydraulic or pneumatic motor may be used for driving a mechanical actuator, in particular a linear mechanical actuator, such as a ball screw, threaded rod actuator, rack and pinion actuator, etc. Still more alternatively, the pressing actuator arrangement 6f may include a high-torque electric motor that is drivingly connected to the toggle-mechanism 6e via a rotary-to-linear transmission device, such as an eccentric mechanism or a crankshaft arrangement. Even furthermore alternatively, the pressing actuator arrangement 6f may include one or more high-torque electric motors that are integrally mounted in the toggle-mechanism 6e and directly drivingly connected with a rotating member or pivoting link of the toggle-mechanism 6e.

The moveable first mold part 3a may be directly or indirectly attached to the pressing member 6d. This means that there may for example be an intermediate member arranged between moveable first mold part 3a and the pressing member 6d, for example a load cell for detecting pressing force, or the like.

The stationary second mold part 3b is typically stationary during the pressing action but may nevertheless be adjustable in the pressing direction D_{P} in the time period between consecutive pressing actions, as will be described more in detail below.

In some example embodiments, the toggle press 6a includes a front structure 6b and a rear structure 6c, wherein the toggle-mechanism 6e is connected also to the rear structure 6c, and wherein the stationary second mold part 3b is attached to the front structure 6b.

The stationary second mold part 3b may be directly or indirectly attached to the front structure 6b. This means that there may for example be an intermediate member arranged between stationary second mold part 3b and the front structure 6b, for example a load cell for detecting pressing force, or the like.

The front and rear structures 6b, 6c of the toggle press 6a represent two rigid and structurally relevant parts that must be interconnected by some kind of structurally rigid construction for ensuring that the front and rear structures 6a, 6c do not separate from each other during pressing action. The front and rear structures 6b, 6c may have many different forms, depending on the specific circumstance. For example, the front and rear structures 6b, 6c may have a plate-like shape, in particular rectangular plate-like shape, thereby enabling cost-effective manufacturing and the possibility of using the corner regions of the plate-shaped front and rear structures 6b, 6c for attachment to a common rigid frame structure.

In fact, the toggle press 6a typically comprises a rigid frame structure defined by the front structure 6b, the rear structure 6c and an intermediate frame structure that connects the front structure 6b with the rear structure 6c.

In some example embodiments, the toggle press 6a comprises a rigid frame structure defined by the front structure 6b, the rear structure 6c and an intermediate linear guiding arrangement 14 that connects the front structure 6b with the rear structure 6c, wherein the pressing member 6d is movably attached to the linear guiding arrangement 14 and moveable in the pressing direction D_{P}. The rigid frame structure may be position on an underlying support frame 38 for providing the desired height and angular inclination of the toggle pressing module 6.

In other words, the intermediate frame structure may be provided by an intermediate linear guiding arrangement 14 that has a dual functionality in terms of providing structural strength and rigidity to the toggle press 6a, providing a rigid connection between the front and rear structure 6b, 6c, and additionally providing an intermediate linear guiding arrangement 14 for guiding of the pressing member 6d.

For enabling cost-effective and strong frame structure of the toggle press 6a, the intermediate linear guiding arrangement 14 may comprises four tie bars 37, of which one is arranged in each corner region of the plate-shaped front and rear structure 6b, 6c. The tie bars are for example cylindrical and corresponding cylindrical holes may be provided in the corner regions of the plate-shaped front and rear structure 6b, 6c for receiving said tie bars.

The pressing member 6d may have any structural shape. However, in some example embodiments, also the pressing member has at least partly a plate-like shape, in particular a rectangular plate-like shape, thereby enabling cost-effective manufacturing and the possibility of using the corner regions of the plate-shaped pressing member 6d for attachment to the intermediate linear guiding arrangement 14. Hence, the toggle press 6a may in some example embodiments be referred to as a three platen press.

The toggle press 6a is installed, or arranged for being installed, with the pressing direction of the pressing member 6d arranged or oriented primarily in a horizontal direction D_{H}. Having the pressing direction arranged primarily in a horizontal direction D_{H} means herein that that pressing direction is arranged closer to the horizontal direction than the vertical direction, i.e. below 45 degrees. Specifically, the toggle press 6a may be installed, or arranged for being installed, with the pressing direction of the pressing member 6d arranged within 20 degrees from the horizontal direction, and more specifically with the pressing direction parallel with the horizontal direction.

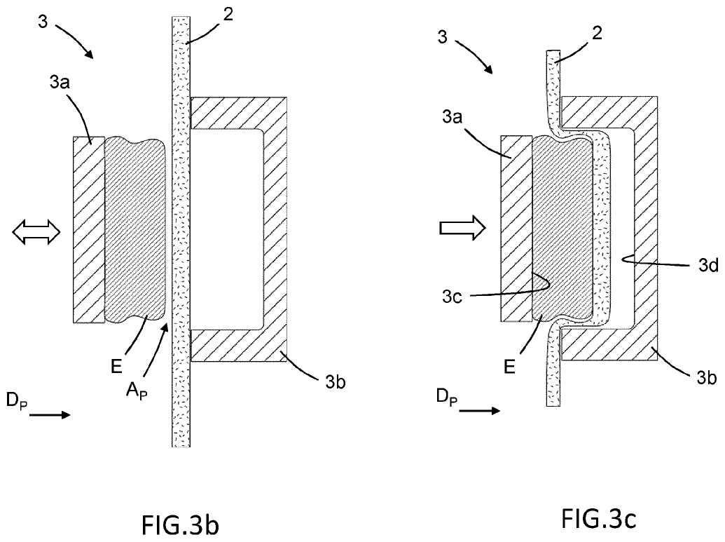

The toggle press 6a is for example installed with the pressing direction D_{P} of the pressing member 6d arranged in the horizontal direction, as illustrated in FIGS. 1a-b, 3a and 4a-b. However, with reference to FIGS. 6a-b, the beneficial aspects of enabling a compact overall design of the cellulose product forming unit U, with a low build-height, is also obtainable when the toggle press 6a is installed in a slightly inclined state, depending on the circumstances. Consequently, the beneficial aspects of the cellulose product toggle pressing module 6 may be deemed obtainable with the toggle press 6a arranged with the pressing direction D_{P} of the pressing member 6d arranged primarily in a horizontal direction D_{H}, i.e. with the pressing direction D_{P} of the pressing member 6d arranged more in a horizontal direction D_{H} than vertical direction D_{V}. In other words, the toggle press 6a may be installed with the pressing direction D_{P} of the pressing member 6d arranged with an installation angle 13 in the range of 0-44 degrees, in particular in the range of 0-20 degrees, wherein said installation angle is defined by the pressing direction D_{P} and the horizontal direction D_{H}.

Furthermore, as illustrated in FIGS. 6a-b, the beneficial aspect of enabling a compact overall design of the cellulose product forming unit U, and a low build-height, is obtainable both when the rear structure 6c of the toggle press 6a is located higher up than the front structure 6b of the toggle press, as illustrated in FIG. 6a, and when the front structure 6b of the toggle press 6a is located higher up than the rear structure 6c of the toggle press, as illustrated in FIG. 6b. Just as an example, in FIG. 6a a power source 39 for the pressing actuator arrangement 6f is illustrated installed under the support frame 38, and in FIG. 6b for example a product plundering arrangement 48 is illustrated installed under the support frame 38.

In some example embodiments, the toggle press 6a further includes a feeding device 16 for providing intermittent feeding of the air-formed cellulose blank structure 2 into a pressing area 15 located between the first and second mold parts 3a, 3b, wherein the feeding device 16 is arranged for feeding the air-formed cellulose blank structure 2 primarily vertically downwards into the pressing area 15, specifically for feeding the air-formed cellulose blank structure 2 downwards with a feeding angle 49 of less than 20 degrees from a vertical direction into the pressing area 15, and more specifically for feeding the air-formed cellulose blank structure vertically downwards into the pressing area 15.

As described above, the term primarily vertically here means feeding the blank structure in a direction that is arranged more vertical than horizontal. In other words, a linear part of the feeding device 16 is oriented for defining an angle 49 with a vertical direction in the range of 0-44 degrees, in particular 0-20 degrees. Consequently, the feeding device 16 may be deemed being located primarily above the forming mold 3.

Moreover, the laid-down arrangement of the pressing module 6, such that the pressing direction D_{P} is oriented primarily in the horizontal direction D_{H}, also results in that a plane defined by interior, typically substantially flat, side surfaces of the first and second mold parts 3a-b is arranged primarily in the vertical direction D_{V}, i.e. defining an angle in the range of 0-44 degrees, in particular 0-20 degrees, to the vertical direction D_{V}. The interior flat side surfaces of the first and second mold parts 3a-b refers to those surfaces of the first and second mold parts 3a-b that face each other and surround the pressing surfaces of the pressing cavity.

According to some example embodiments, the feeding device 16 for feeding the air-formed cellulose blank structure 2 into the pressing area 15 may include a motorized feeding roller or motorized pair of feeding rollers, or an elongated vacuum belt feeder or an elongated tractor belt feeder or the like, and with an intended feeding direction arranged primarily in a vertical direction D_{V}, specifically arranged with a direction of elongation 17 within 20 degrees from the vertical direction D_{V}, and more specifically arranged in parallel with the vertical direction D_{V}.

The toggle-mechanism 6e of the toggle press 6a may have a large variety of designs and implementations. The basic requirement of the toggle-mechanism 6e is to generate a pressing force amplification, thereby enabling the use of a relatively low-cost and low-capacity pressing actuator arrangement 6f in term of pressing force. The pressing force amplification is accomplished by a corresponding reduction of pressing speed of the pressing module. Hence, the toggle-mechanism 6e amplifies and slows down a pressing force/speed compared with the force/speed of the pressing actuator arrangement 6f.

In general, and with reference to the example embodiment of FIGS. 1a-b, 3a and 4a-b, the toggle-mechanism 6e includes a first link member 18 and a second link member 19, wherein the pressing actuator arrangement 6f is directly or indirectly drivingly connected to the first or second link member 18, 19, such that actuation of the pressing actuator arrangement 6f results in motion of the pressing member 6d.

More in detail, the toggle-mechanism 6e may in some example embodiments include a first link member 18 and a second link member 19, each having first and second pivot connections 18a, 18b, 19a, 19b, wherein the first pivot connection 18a of the first link member 18 is pivotally connected to the rear structure 6c, wherein the first pivot connection 19a of the second link member 19 is pivotally connected to the pressing member 6d, wherein the second pivot connection 18b of the first link member 18 is pivotally connected to the second pivot connection 19b of the second link member 19, and wherein the pressing actuator arrangement 6f is directly or indirectly drivingly connected to the first or second link member 18, 19 for adjusting a level of alignment between the first and second link members 18, 19, such that actuation of the pressing actuator arrangement 5f results in motion of the pressing member 6d.

The fact that the second pivot connection 18b of the first link member 18 is pivotally connected to the second pivot connection 19b of the second link member 19 means that the second pivot connection 18b of the first link member 18 is the same as the second pivot connection 19b of the second link member 19.

The effect of adjusting a level of alignment between the first and second link members 18, 19 is illustrated in FIG. 4a-b. The alignment between the first and second link members 18, 19 is determined by an alignment angle 22 defined by longitudinal directions of the first and second link members 18, 19, as seen in a side-view according to FIGS. 4a and 4b, wherein the longitudinal direction 18d of the first link member 18 is defined by a straight line passing the first and second pivot connections 18a, 18b of the first link member, and the longitudinal direction 19d of the second link member 19 is defined by a straight line passing the first and second pivot connections 19a, 19b of the second link member 19.

In FIG. 4b, the alignment angle 22 is 180 degrees, which corresponds to alignment of the first link member 18 with the second link member 19. This actuating position of the toggle-mechanism 6e may be referred to as a force equilibrium position. The force equilibrium position is a position in which all forces are in balanced condition and the effect of forces cancel each other. In other words, in the force equilibrium position the force required by the pressing actuator arrangement 6f is equal to zero.

In some example embodiment, depending on the specific design of the toggle-mechanism 6e, said pressing operations involves controlling the pressing actuator arrangement 6f for setting the toggle-mechanism 6e in said force equilibrium position.

In some example embodiments of the toggle mechanism design, such as for example shown in FIGS. 4a and 4b, the force equilibrium position corresponds to the maximal extended operating position of the toggle-mechanism 6e.

The toggle mechanism 6e illustrated in the example embodiment of FIG. 4a-b may be referred to as five-point double-toggle mechanism, meaning that there are two individual toggle mechanisms arranged side-by-side for providing a better force pressing force distribution to the pressing member 6d, and wherein each of said two individual toggle mechanisms include five pivot points.

Specifically, in the example embodiment of FIG. 4a-b, the pressing actuator arrangement 6f is drivingly connected to a single cross head 20, and a cross head link member 21 has a first connection 21a that is pivotally connected to the cross head 20 and a second connection 21b that is pivotally connected to a third pivot connection 18c of the first link member 18.

In other words, the toggle mechanism 6e of the example embodiment of FIGS. 4a-b comprises a single cross head that drives a first and second individual toggle mechanisms arranged side-by-side, each including a first link member 18, a second link member 19 and a cross head link member 21, wherein the first link member 18 pivotally connected to a second link member 19 and to the rear structure 6c, wherein the second link member 19 is pivotally connected to the pressing member 6d, wherein the cross head link member 21 is pivotally connected to the first link member 18 and the cross head 20.

Many alternative designs of the toggle-mechanism 6e are possible within the scope of the disclosure. For example, the cross head link member 21 may be pivotally connected to the second link member 19 and the cross head 20. Furthermore, the second and third pivot connections 18b 18c of the first link member 18 may alternatively be a common pivot connection.

Moreover, the toggle mechanism 6e may be three-point single-toggle mechanism as illustrated in FIG. 6a, wherein the toggle-mechanism 6e includes a first link member 18 pivotally connected to a second link member 19, wherein the first link member 18 is also pivotally connected rear structure 6c and the second link member 19 is pivotally connected to the front structure 6d, and a pressing actuator arrangement 6f is directly or indirectly drivingly connected to the first or second link member 18, 19, such that actuation of the pressing actuator arrangement 6f results in motion of the pressing member 6d.

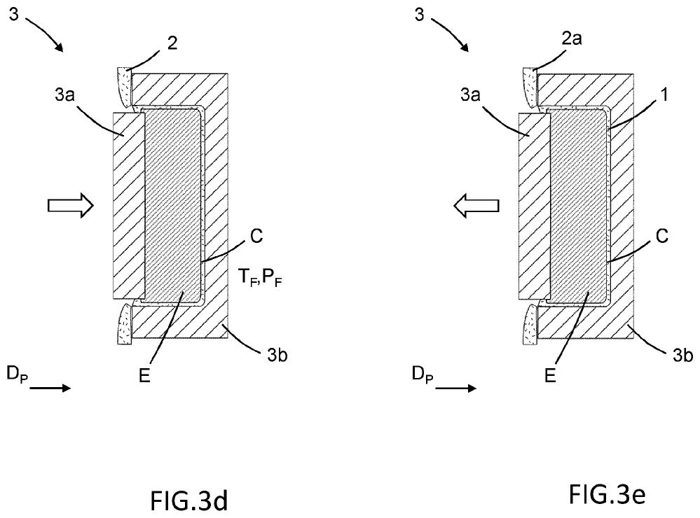

Still a further example design of the toggle-mechanism 6e is schematically illustrated in FIG. 7a, which shows a three-point double-toggle mechanism, i.e. two three-point single-toggle mechanisms as described with reference to FIG. 6a, and with a pressing or pulling actuator arrangement 6f directly or indirectly drivingly connected to the first and/or second link member 18, 19 of both said single-toggle mechanisms. Moreover, in this example embodiment, an electric servo motor is depicted as actuator arrangement 6f.

According to yet a further example embodiment, the toggle-mechanism 6e as schematically illustrated in FIG. 7b includes a three-point double-toggle mechanism, i.e. two three-point single-toggle mechanisms as described with reference to FIG. 6a, but here operating in opposite directions and with an actuator arrangement 6f arranged between, and directly or indirectly drivingly connected to, the first and/or second link member 18, 19 of both said single-toggle mechanisms.

With reference again to FIGS. 3a and 4a-b, in some example embodiments, the toggle press 6a further includes: a pressing force indicating arrangement 6g, an adjustment mechanism 23 for enabling adjustment of a distance between the first and second mold parts 3a, 3b in the pressing direction while having the toggle-mechanism 6e in a non-moving operating state, and an adjustment actuator arrangement 25 configured for driving the adjustment mechanism 23, wherein the electronic control system 6h is operatively connected to the pressing force indicating arrangement 6g and configured to control operation of the adjustment actuator arrangement 25, based on pressing force indicating feedback information received from the pressing force indicating arrangement 6g.

For example, the mechanical adjustment mechanism 23 may comprise four gear wheels 26a-d, each having internal thread for threading mounting on a correspondingly threaded end portion of a tie bar of the linear guiding arrangement 14, and each 26a-d having external gear teeth for being driven by one or more motors of the adjustment actuator arrangement 25.

For example, as illustrated in FIGS. 3a and 4a-b, each of said four gears 26a-d of the mechanical adjustment mechanism 23 may be in contact with, and driven by, a single central gear wheel 27, which is powered by a single motor of the adjustment actuator arrangement 25.

Operation of the adjustment actuator arrangement 25 causes the mechanical adjustment mechanism 23 to alter the distance 24 between front and rear structure 6b, 6c, in the pressing direction, for enabling adjustment of a distance between the first and second mold parts 3a, 3b while having the toggle-mechanism 6e in a non-moving operating state. This means that said adjustment of distance is not caused by movement of toggle-mechanism, but rather from the change of distance between the between front and rear structure 6b, 6c.

In the example embodiment of FIGS. 3a and 4a-b, operation of the mechanical adjustment mechanism 23 displaces the rear structure 6c relative to the linear guiding arrangement 14 for altering the distance 24 between front and rear structure 6b, 6c.

Alternatively, operation of the mechanical adjustment mechanism 23 displaces the front structure 6b relative to the linear guiding arrangement 14 for altering the distance 24 between front and rear structure 6b, 6c.

The electronic control system 6h is typically configured to control operation of the adjustment actuator arrangement 25 for adjusting the distance between the first and second mold parts 3a, 3b during a time period between consecutive pressing actions, such that the pressing member 6d during the next pressing cycle is targeted to provide a compression force closer to a predetermined target pressing force.

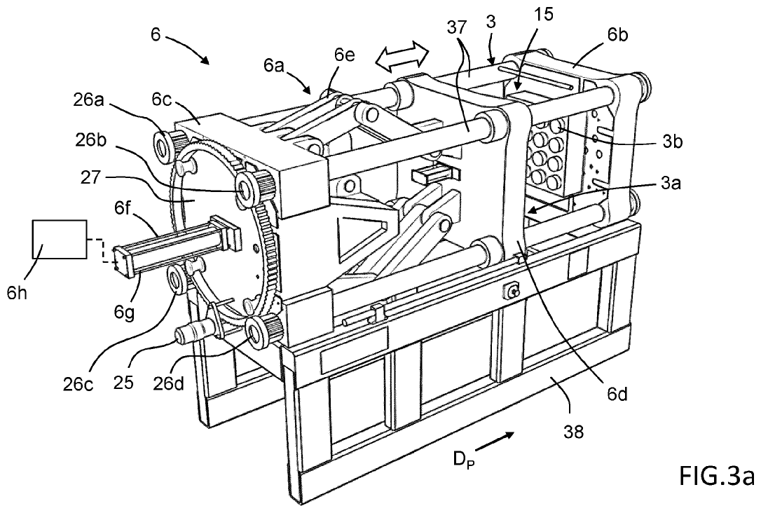

FIG. 5 schematically shows the main process steps of the pressing module 6 during normal operation. The pressing operation flowchart typically starts with the pressing member in stillstand at a standby position S associated with retracted toggle mechanism and open pressing mold 3, as schematically illustrated in FIG. 4a. Upon receiving a command or instruction to initiate a pressing cycle, the second step F of the flow chart is performed, which involves activating the pressing actuator arrangement 6f for pushing the pressing member 6d forwards F, until the forming mold 3 becomes closed and a forming pressure of about 1-100 Mpa, in particular 4-20 Mpa, is applied to the cellulose blank structure in a third step P of the main process. Thereafter, the fourth step R of the flow chart is performed, which involves initiating a return motion of the pressing member 6d towards the start position, i.e. the standby position S.

In case of high speed manufacturing, the process may skip step S, i.e. skip returning completely to the standby position S before initiating the second step F of the flow chart again.

The term maximal stroke state used herein, also referred to as “maximal extended operating position”, refers herein to the maximal forward position obtainable by the toggle mechanism when not being obstructed by the forming mold, the cellulose blank structure or other part, e.g. the aligned state of the first and second link members 18, 19 as shown in FIG. 4b.

In some example embodiments, each of the first and second mold parts 3a, 3b comprises a main rigid plate-shaped body with a typically substantially flat surface configured for facing the other mold part, and at least one pressing surface 3c, 3d defining one or more forming cavities C for forming a cellulose product 1, and with or without additional minor parts, such as spring-loaded cutting devices and/or mold alignment devices, or the like, wherein said substantially flat surfaces of the main rigid plate-shaped body of the first and second mold forming parts 3a, 3b are free from mutual direct contact during a pressing cycle. Consequently, said surfaces of the main rigid plate-shaped bodies are not intended to come in mutual contact and to prevent further pressing motion of the first and second forming mold parts 3a, 3b. However, other parts of the first and second mold parts 3a, 3b may still be in mutual contact during the pressing action, such as spring-loaded cutting devices and/or mold alignment devices, etc., which are not part of said surfaces of the first and second mold parts 3a, 3b.

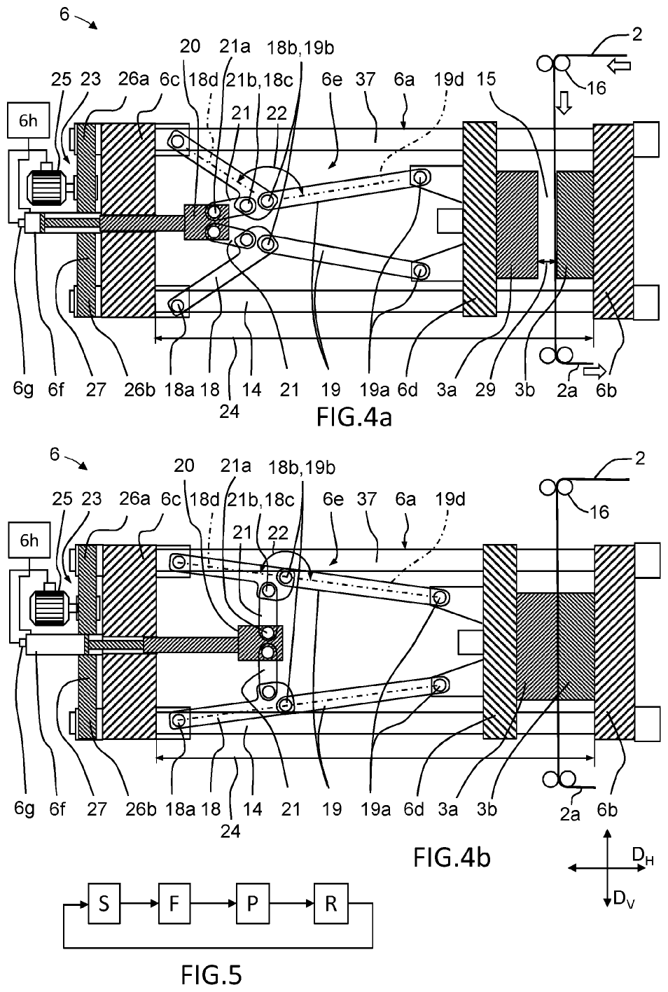

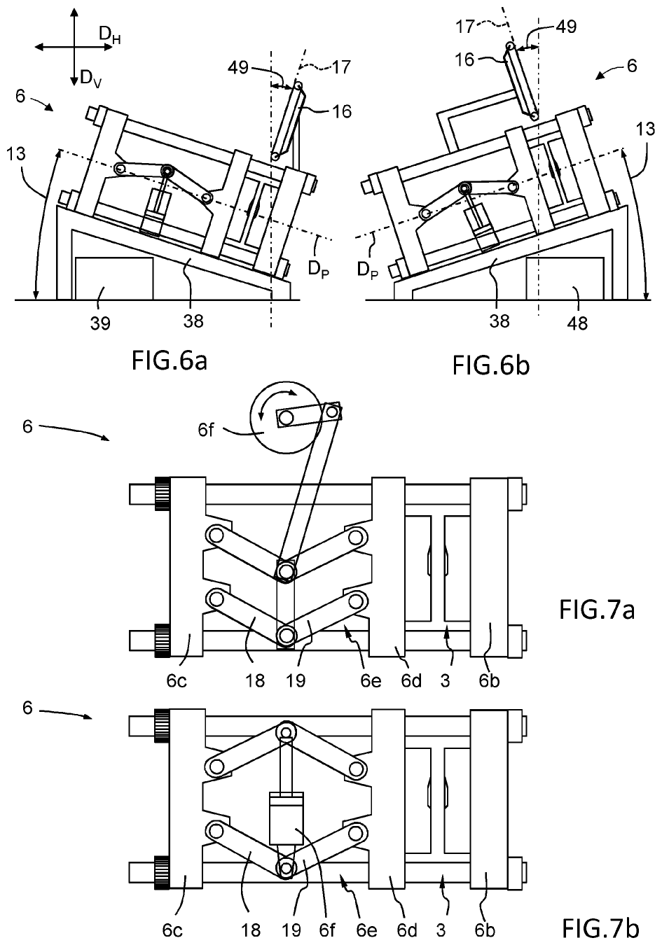

FIGS. 8a-b schematically illustrate how a toggle press 6a may be adjusted using the mechanical adjustment mechanism 23 to obtain different levels of pressing force at maximal extended actuating position, and FIG. 8c shows what happens when the distance between the front and rear structures 6b, 6c is too small, and FIG. 9 shows a schematic illustration of the resulting pressing force for each of these situations. The vertical axis in the diagram of FIG. 9 shows pressing force provided by the toggle press 6a, and the horizontal axis in the diagram of FIG. 9 shows distance 24 between the front and rear structure 6b, 6c of the toggle press 6a. With relatively short distance 24 between the front and rear structure 6b, 6c the first and second link members of the toggle-mechanism will still be non-aligned when arriving at the maximal pressing capacity of the toggle press 6a, and with relatively large distance 24 between the front and rear structure 6b, 6c the first and second link members of the toggle-mechanism will easily reach the aligned position but not produce a large pressing force at this position due to the relatively large remaining mold gap 53 in the forming mold 3.

In FIG. 8a, the distance 24 between front and rear structure 6b, 6c is adjusted to be relatively long, thereby providing a relatively low pressing force when the pressing plate 6d reaches the maximal extended actuating position. In this example embodiment, the maximal extended actuating position of the toggle mechanism 6e is obtained when the first and second link members 18, 19 are aligned. The resulting pressing force at this adjustment position of the mechanical adjustment mechanism 23 is marked with point A in FIG. 9.

In FIG. 8b, the distance 24 between front and rear structure 6b, 6c is reduced, thereby providing a higher pressing force when the pressing plate 6d reaches the maximal extended actuating position. The resulting pressing force at this adjustment position of the mechanical adjustment mechanism 23 is marked with point B in FIG. 9.

When the distance 24 between front and rear structure 6b, 6c is adjusted to be very short, the toggle mechanism 6e may be prevented from reaching the force equilibrium position, i.e. the first and second link members 18, 19 are nom-aligned, as illustrated in FIG. 8c. The resulting pressing force at this adjustment position of the mechanical adjustment mechanism 23 is marked with point C in FIG. 9.

Pressing operation of the pressing module 6 may be performed in a variety of ways. For example, the toggle press 6a may be operated in an open loop manner, wherein no feedback of parameters such as press force or pressing member position is required.

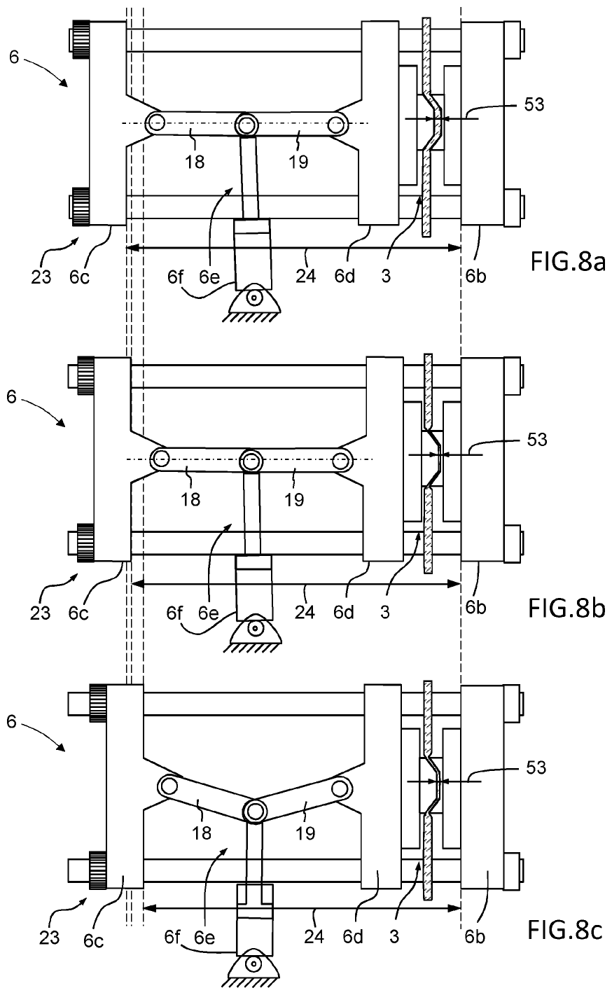

An example embodiment of a control system 40 suitable for controlling the toggle press 6a in an open loop manner is schematically illustrated in FIG. 10a. In this example embodiment, the pressing actuator arrangement 6f is a hydraulic cylinder that is fluidly controlled by a solenoid-operated directional control valve 41 that is fluidly connected to a variable displacement hydraulic pump 42 and a fluid tank 43. Furthermore, a feeding device 16, here in form of an electric motor, is provided for controlling operating of the forming wire 4c, and a pressing member position detection device 44 is provided for ensuring that the pressing member is operated to reach the maximal forward position of the toggle mechanism 6e at each pressing event. Control of the operating state of the directional control valve 41, as well as speed of the feeding device 16, may be controlled by the electronic control system 6h, such as to provide the desired intermittent feeding of the forming wire 4c between subsequent pressing operations of the toggle press 6a.

The pressing member position detection arrangement may for example be a linear position encoder configured to detect the position of the pressing member 6d, or a position encoder for detecting the actuating position of the toggle mechanism 6e, or a position encoder for detecting actuating position of the pressing actuator arrangement 6f, or the like.

According to an alternative control strategy, the control system 40 may be configured for controlling the toggle press 6a in a closed-loop manner, as schematically showed in FIG. 10b. According to this control strategy, the pressing actuator arrangement 6f may be controlled to simply displace the pressing member 6d to a maximal forward position, i.e. alignment angle of 180 degrees or maximal stroke state of the toggle mechanism 6e, and to have the distance 24 between front and rear structure 6b, 6c of the toggle press 6a adjusted beforehand such that the resulting press force equals a target press force. The electronic control system 6h may be configured to control the pressing operation based on feedback data from a pressing force detecting or indicating arrangement, and to adjust the distance 24 between front and rear structure 6b, 6c of the toggle press 6a between consecutive pressing operations for keeping the resulting press force at a target press force. Thereby, variations in process parameters may be better taking care of for ensuring improved quality of the cellulose products 1.

FIG. 10b shows, in addition to the features described with reference to FIG. 10a, an adjustment actuator arrangement 25 configured for driving the mechanical adjustment mechanism 23. The adjustment actuator arrangement 25 may for example be an electric or hydraulic motor. Moreover, the system of FIG. 10b additionally shows a pressing force detection device 6g for providing feedback to the electronic control system 6h.

Consequently, in some example embodiments the toggle press 6a further includes a pressing force indicating arrangement 6g, wherein the electronic control system 6h is operatively connected to the pressing force indicating arrangement 6g and configured to control operation of the pressing actuator arrangement 6f based on pressing force indicating feedback information received from the pressing force indicating arrangement 6g.

The pressing force indicating arrangement 6g typically includes some type of measurement device for measuring a level of a press force parameter. Consequently, the press force indicating feedback information typically includes, or is derived from, a measured process variable of the toggle press 6a.

Operational control of the pressing actuator arrangement 6f based on pressing force indicating feedback information received from the pressing force indicating arrangement 6g may for example involve press force feedback control, position feedback control, or open loop control with automatic self-tuning between consecutive pressing cycle.

The pressing force indicating arrangement may for example correspond to one or more pressing force sensors of some type being located at one or more suitable position on the pressing module 6. For example, a load cell, such as a strain gauge force sensor, or the like, may be provided at or within the forming mold 3, or between toggle mechanism 6e and rear structure 6c, or between the toggle mechanism 6e and the forming mold 6.

Alternatively, or in combination with above, the pressing force indicating arrangement may correspond to a deformation sensor, such as a strain gauge sensor, which is configured for sensing deformation of for example one, two or all tie bars of the intermediate linear guiding arrangement 14. Alternatively, a deformation sensor, such as a strain gauge sensor, laser sensor, etc. may be provided for sensing deformation of the front structure 6b, or the rear structure 6c, or the pressing member 6d, or the toggle mechanism 6e.

The electronic control system may in some example embodiments be configured to control the adjustment actuator arrangement 25, for example for adjusting the maximal pressing force of the toggle press for a specific cellulose blank structure.

Consequently, the toggle press may include a pressing force indicating arrangement 6g, and the electronic control system 6h may be operatively connected to the pressing force indicating arrangement 6g, and the control system may be configured for controlling operation of the adjustment actuator arrangement, based on pressing force indicating feedback information received from the pressing force indicating arrangement 6g, for adjusting the distance between the front structure and rear structure in the pressing direction, during a time period between consecutive pressing actions. As a result, the electronic control system may adjust the maximal pressing force.

This is for example accomplished by receiving pressing force indicating feedback information from the pressing force indicating arrangement 6g during a first pressing cycle, determining whether adjustment of the current operating position, i.e. distance 24 between the front and rear structure 6b, 6c, of the toggle press is appropriate, and if not, adjusting the distance 24 between the front and rear structure 6b, 6c by appropriate operation of the adjustment actuator arrangement 25, such that the operating position and/or pressing force during the next pressing cycle is more in line with a target operating position and/or pressing force. In other words, the electronic control system does not need active control and adjustment of the input force to the toggle mechanism 6e provided by the pressing actuator arrangement 6f for adapting the pressing force of the pressing member 6d, but may instead rely merely on active control of the adjustment actuator arrangement 25.

This control strategy may be implemented by adjusting the distance 24 between the front and rear structure 6b, 6c, such that the toggle pressing module 6 arrives at the target pressing force simultaneously with arriving at the at maximal stroke state of the toggle mechanism 6e. In other words, the electronic control system is configured for obtaining pressing force indicating information from the pressing force indicating arrangement 6g during the pressing actions of said normal running of the toggle press 6a, and when for example the pressing force indicating information indicates that the pressing force PF is continuously, over a set of pressing cycles, above a target pressing force, the distance 24 between front and rear structure 6b, 6c of the toggle press 6a would be adjusted, during consecutive pressing actions, such that the resulting press force equals the target press force.

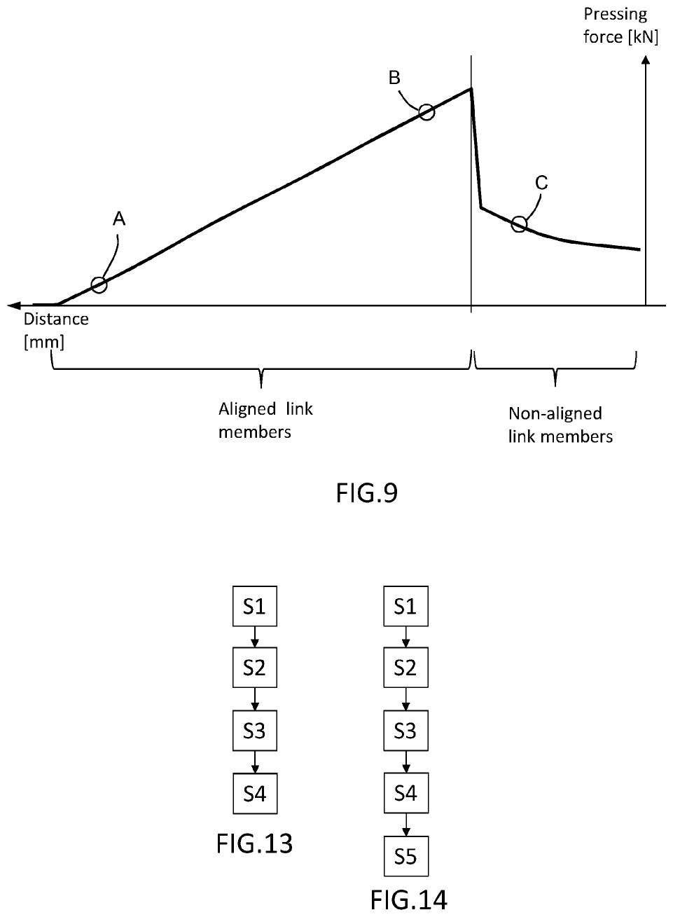

According to an alternative example embodiment of the product forming unit U of the present disclosure, various aspects of the product forming unit U may have another design, functionality and/or layout, as schematically illustrated in FIG. 11.

For example, the forming wire 4c may extend all the way to the pressing module 6, thereby effectively eliminating the need for an intermediate transport device 16.

Furthermore, the forming section 4d of the forming wire 4c may be arranged for extending in a horizontal direction D_{H}. The cellulose blank structure 2 is in this embodiment air-formed onto the forming section 4d, and transported from the forming section 4d by the forming wire 4c in the horizontal direction D_{H}. After forming of the cellulose blank structure 2 onto the forming section 4d, the formed cellulose blank structure 2 is transported from the forming section 4d in the horizontal direction D_{H} and further towards the pressing module 6.

Furthermore, the blank dry-forming module 4 of the embodiment illustrated in FIG. 11 has a vertical distribution direction of the cellulose fibers F from the mill 4a to the forming wire 4c through the forming chamber 4b. A vertical flow of air is thus feeding the cellulose fibers F from the mill 4a to the forming section 4d.

In addition, the toggle press 6a is installed with the pressing direction D_{P} of the pressing member 6d arranged in the vertical direction D_{V}.

The use of a toggle pressing module for forming non-flat cellulose products from an air-formed cellulose blank structure has many advantages over use of large-capacity conventional toggle-less hydraulic presses, such as low-cost, low-weight, fast cycle operation and compactness. Consequently, the toggle pressing module 6 may in certain circumstances be a useful alternative to a conventional vertically standing hydraulic press.

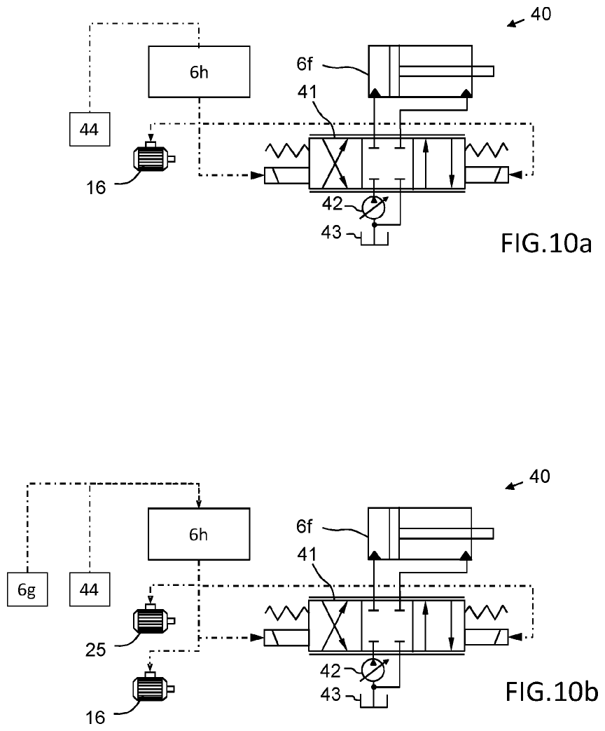

The toggle pressing module 6 schematically illustrated in FIGS. 12a-b corresponds to the toggle pressing module 6 described above with reference to FIGS. 4a-b and reference is made to the disclosure relating to FIGS. 4a-b for details of the toggle pressing module 6, except for the pressing actuator arrangement 6f, which here is schematically implemented as an electrically-powered ball-screw linear actuator. The ball-screw linear actuator may for example comprise a rod 50 drivingly connected to an electric motor and having a helical track for holding rolling balls that may circulate in a track in the cross head 20.

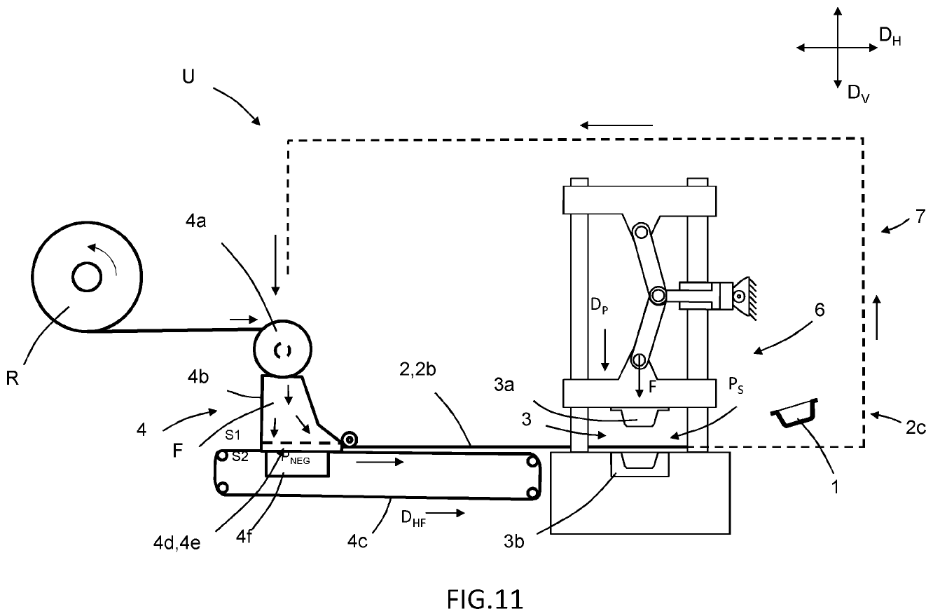

The basic steps of the method for forming non-flat cellulose products from an air-formed cellulose blank structure in a product forming unit U is described below with reference to FIG. 13. The product forming unit U comprises a blank dry-forming module 4 with a moveable forming wire 4c, a toggle pressing module 6 with a toggle press 6a and a forming mold 3, and an electronic control system 6h operatively connected to the forming wire 4c and the toggle pressing module 6; wherein the toggle press 6a includes a pressing member 6d movably arranged in a pressing direction, a toggle-mechanism 6e drivingly connected to the pressing member 6d, a pressing actuator arrangement 6f drivingly connected to the toggle-mechanism 6e; and wherein the forming mold 3 includes a moveable first mold part 3a attached to the pressing member 6d and a second mold part 3b. The method comprises a first step S1 of air-forming a cellulose blank structure 2 onto the forming wire 4c by means of the blank dry-forming module 4. The method further comprises a second step S2 of feeding the air-formed cellulose blank structure 2 into a pressing area defined by the first and second, spaced apart, mold parts 3a, 3b. Moreover, the method comprises a third step S3 of controlling operation of the pressing actuator arrangement 6f by means of the electronic control system 6h for performing pressing operations, which involves driving the pressing member 6d in the pressing direction by means of the toggle-mechanism 6e, and thereby forming the non-flat cellulose product from the air-formed cellulose blank structure by pressing the first mold part 3a against the second mold part 3b. Finally, the method comprises a fourth step S4 of controlling operation of the forming wire 4c by means of the electronic control system 6h for intermittently feeding the forming wire 4c between subsequent pressing operations.

Said fourth step S4 of controlling operation of the pressing actuator arrangement 6f may be performed a many different ways while still solving the problem of forming non-flat cellulose products from an air-formed cellulose blank structure using a low-cost, compact and low-weight cellulose product pressing module.

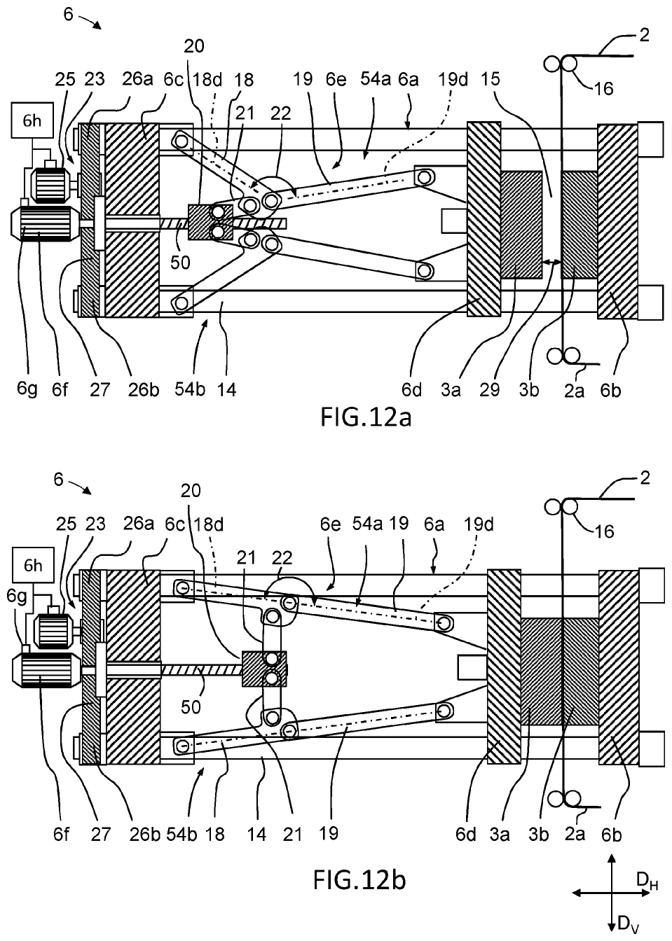

With reference to FIG. 14, according to some example embodiments, the toggle press 6a further includes a pressing force indicating arrangement 6g, an adjustment mechanism 23 for enabling adjustment of a distance between the first and second mold parts 3a, 3b in the pressing direction while having the toggle-mechanism 6e in a non-moving operating state, and an adjustment actuator arrangement 25 configured for driving the adjustment mechanism 23. The method may then, in addition to steps S1-S4 as described with reference to FIG. 13, further include a fifth step S5 of controlling operation of the adjustment actuator arrangement 25 based on pressing force indicating feedback information received from the pressing force indicating arrangement 6g.

Specifically, the fifth step S5 of controlling operation of the adjustment actuator arrangement 25 may involve adjusting the distance between the first and second mold parts 3a, 3b during a time period between consecutive pressing actions, such that the pressing member 6d during the next pressing cycle is targeted to provide a compression force closer to a predetermined target pressing force.

The feedback controller 6h may be implemented in a variety of alternative ways, as known to the person skilled in the art, such as for example a P controller, PI controller, PID controller, Optimal control, such as for example Linear Quadratic (LQ) controller, or the like.

For example, a PID (Proportional-Integral-Derivative) controller is a control loop mechanism employing feedback for providing a continuously modulated control of the process to be controlled. A feedback controller, such as for example a PID controller, continuously calculates an error value as the difference between a desired setpoint (SP) and a measured process variable (PV) and applies a correction based on proportional, integral, and derivative terms of said error value. The setpoint (SP) may for example be a specific predetermined compression force and the measured process variable (PV) may for example be measured pressing force as detected by a strain gauge force sensor located on a tie bar 37 of the toggle press 6a.

The cellulose product toggle pressing module 6 according to the disclosure may also be very useful for forming non-flat cellulose products 1 from an air-formed cellulose blank structure 2, even without the intermittent operating process of the forming wire 4c of the blank dry-forming module 4. Hence, in cellulose product toggle pressing modules having a buffer arranged between the blank dry-forming module 4 and the pressing module 6, and wherein the blank dry-forming module 4 and associated forming wire 4c operates continuously with more or less constant operating speed, the cellulose product toggle pressing module according to the disclosure may still deliver various advantageous aspects, such as compactness, cost-efficiency, and rapid operating cycle.

This is for example provided by a cellulose product toggle pressing module 6 for forming non-flat cellulose products 1 from an air-formed cellulose blank structure 2, wherein the toggle pressing module 6 comprises a toggle press 6a including a pressing member 6d movably arranged in a pressing direction, a toggle-mechanism 6e drivingly connected to the pressing member 6d, a pressing actuator arrangement 6f drivingly connected to the toggle-mechanism 6e for controlling motion of the toggle-mechanism between a retracted operating position and an extended operating position. The toggle pressing module 6 further comprises a forming mold 3 including a moveable first mold part 3a attached to the pressing member 6d and a second mold part 3b, as well as an adjustment mechanism 23 for enabling adjustment of a distance between the first and second mold parts 3a, 3b in the pressing direction while having the toggle-mechanism 6e in a non-moving operating state, and an adjustment actuator arrangement 25 configured for driving the adjustment mechanism 23. The toggle pressing module 6 additionally comprises a pressing force indicating arrangement 6g, and an electronic control system 6h operatively connected to the pressing force indicating arrangement 6g, the pressing actuator arrangement 6f and the adjustment actuator arrangement 25. The electronic control system 6h is configured for controlling operation of pressing actuator arrangement 6f for driving the pressing member 6d in the pressing direction by setting the toggle-mechanism 6e in the extended operating position, and thereby forming the non-flat cellulose product from the air-formed cellulose blank structure by pressing the first mold part 3a against the second mold part 3b, and the electronic control system is configured for controlling operation of the adjustment actuator arrangement 25, based on pressing force indicating feedback information received from the pressing force indicating arrangement 6g.

Similarly, the disclosure includes a corresponding method for forming non-flat cellulose products from an air-formed cellulose blank structure in a toggle pressing module 6. The met toggle pressing module 6 comprises: a toggle press 6a including a pressing member 6d movably arranged in a pressing direction, a toggle-mechanism 6e drivingly connected to the pressing member 6d, a pressing actuator arrangement 6f drivingly connected to the toggle-mechanism 6e for controlling motion of the toggle-mechanism between a retracted operating position and an extended operating position; a forming mold 3 including a moveable first mold part 3a attached to the pressing member 6d and a second mold part 3b; an adjustment mechanism 23 for enabling adjustment of a distance between the first and second mold parts 3a, 3b in the pressing direction while having the toggle-mechanism 6e in a non-moving operating state; an adjustment actuator arrangement 25 configured for driving the adjustment mechanism 23; a pressing force indicating arrangement 6g; and an electronic control system 6h operatively connected to the pressing force indicating arrangement 6g, the pressing actuator arrangement 6f and the adjustment actuator arrangement 25. The method comprises: air-forming a cellulose blank structure 2 onto the forming wire 4c by means of the blank dry-forming module 4; feeding the air-formed cellulose blank structure 2 into a pressing area defined by the first and second, spaced apart, mold parts 3a, 3b; controlling operation of the pressing actuator arrangement 6f for performing pressing operations, which involves driving the pressing member 6d in the pressing direction by setting the toggle-mechanism 6e in the extended operating position, and thereby forming the non-flat cellulose product from the air-formed cellulose blank structure by pressing the first mold part 3a against the second mold part 3b; and controlling operation of the adjustment actuator arrangement 25, based on pressing force indicating feedback information received from the pressing force indicating arrangement 6g.

Adjustment of a distance between the first and second mold parts 3a, 3b in the pressing direction while having the toggle-mechanism 6e in a non-moving operating state means that the adjustment is not caused by movement of toggle-mechanism, but caused by some other feature.

Furthermore, the step of controlling operation of pressing actuator arrangement for driving the pressing member in the pressing direction by setting the toggle-mechanism in the extended operating position generally involves setting the toggle-mechanism in a maximal extended operation position.

It will be appreciated that the above description is merely exemplary in nature and is not intended to limit the present disclosure, its application or uses. While specific examples have been described in the specification and illustrated in the drawings, it will be understood by those of ordinary skill in the art that various changes may be made and equivalents may be substituted for elements thereof without departing from the scope of the present disclosure as defined in the claims. Moreover, features of the example embodiments described herein may be combined with features of other example embodiments described herein. Furthermore, modifications may be made to adapt a particular situation or material to the teachings of the present disclosure without departing from the essential scope thereof. Therefore, it is intended that the present disclosure is not limited to the particular examples illustrated by the drawings and described in the specification as the best mode presently contemplated for carrying out the teachings of the present disclosure, but that the scope of the present disclosure will include any embodiments falling within the foregoing description and the appended claims. Reference signs mentioned in the claims should not be seen as limiting the extent of the matter protected by the claims, and their sole function is to make claims easier to understand.

1. A product forming unit for manufacturing non-flat cellulose products from an air-formed cellulose blank structure, the product forming unit comprising:
a blank dry-forming module with a moveable forming wire,
a toggle pressing module with a toggle press and a forming mold, and
an electronic control system operatively connected to the forming wire and the toggle press;
wherein the blank dry-forming module is configured for air-forming the cellulose blank structure onto the forming wire;
wherein the toggle press includes a pressing member movably arranged in a pressing direction, a toggle-mechanism drivingly connected to the pressing member, and a pressing actuator arrangement drivingly connected to the toggle-mechanism;
wherein the forming mold includes a moveable first mold part attached to the pressing member and a second mold part;
wherein the electronic control system is configured for controlling operation of the pressing actuator arrangement for performing pressing operations, which involves driving the pressing member in the pressing direction by the toggle-mechanism, and thereby forming the non-flat cellulose product from the air-formed cellulose blank structure by pressing the first mold part against the second mold part; and
wherein the electronic control system further is configured for intermittently feeding the forming wire between subsequent pressing operations.

2. The product forming unit according to claim 1, wherein the toggle press is installed, or arranged for being installed, with the pressing direction of the pressing member arranged primarily in a horizontal direction.

3. The product forming unit according to claim 1, wherein the toggle press further includes:
a pressing force indicating arrangement,
an adjustment mechanism for enabling adjustment of a distance between the first and second mold parts in the pressing direction while having the toggle-mechanism in a non-moving operating state, and
an adjustment actuator arrangement configured for driving the adjustment mechanism,
wherein the electronic control system is operatively connected to the pressing force indicating arrangement and configured to control operation of the adjustment actuator arrangement, based on pressing force indicating feedback information received from the pressing force indicating arrangement.

4. The product forming unit according to claim 3, wherein the electronic control system is configured to control operation of the adjustment actuator arrangement for adjusting the distance between the first and second mold parts during a time period between consecutive pressing actions, such that the pressing member during the next pressing cycle is targeted to provide a compression force closer to a predetermined target pressing force.

5. The product forming unit according to claim 3, wherein the pressing force indicating arrangement includes one or more of the following sensors: a load cell, a deformation sensor, or a strain gauge force sensor, and wherein said one or more sensors is located at or within the forming mold, or on the toggle-mechanism, or between the toggle mechanism and a rear structure of a rigid frame structure of the toggle press, or between the toggle-mechanism and the forming mold, or at the rigid frame structure of the toggle press, or at a tie bar of an intermediate linear guiding arrangement of the toggle press.

6. The product forming unit according to claim 1, wherein the blank dry-forming module further comprises a mill and a forming chamber, wherein the forming wire is arranged in connection to the forming chamber, wherein the mill is configured for separating fibres from a cellulose raw material, wherein the forming chamber is configured for distributing the separated fibers onto a forming section of the forming wire for forming the cellulose blank structure.

7. The product forming unit according to claim 1, wherein the product forming unit further comprises a cellulose blank feeding device, in particular a conveyer belt and/or a set of feeding rollers, configured for transporting the air-formed cellulose blank structure from forming wire of the blank dry-forming module to the forming mold of the toggle pressing module, wherein the electronic control system is configured for providing substantially synchronized operation of the forming wire and feeding device.

8. The product forming unit according to claim 1, wherein the forming mold is configured for forming the cellulose products from the cellulose blank structure by heating the cellulose blank structure to a forming temperature in the range of 100-300° C., and pressing the cellulose blank structure with a forming pressure in the range of 1-100 MPa.

9. The product forming unit according to claim 1, wherein the product forming unit further comprises a blank recycling module configured for transporting residual parts of the cellulose blank structure from the pressing module to the blank dry-forming module.

10. The product forming unit according to claim 1, wherein the product forming unit is adapted for intermittently feeding the cellulose blank structure from the blank dry-forming module by the forming wire in a first feeding direction, and for intermittently feeding the cellulose blank structure to the pressing module in a second feeding direction, wherein the second feeding direction differs from the first feeding direction, specifically wherein the second feeding direction is opposite to, or essentially opposite to, the first feeding direction.

11. The product forming unit according to claim 1, wherein the first feeding direction is an upwards direction and the second feeding direction is a downwards direction.

12. A method for forming non-flat cellulose products from an air-formed cellulose blank structure in a product forming unit that comprises a blank dry-forming module with a moveable forming wire, a toggle pressing module with a toggle press and a forming mold, and an electronic control system operatively connected to the forming wire and the toggle pressing module, wherein the toggle press includes a pressing member movably arranged in a pressing direction, a toggle-mechanism drivingly connected to the pressing member, a pressing actuator arrangement drivingly connected to the toggle-mechanism, wherein the forming mold includes a moveable first mold part attached to the pressing member and a second mold part, the method comprising:
air-forming a cellulose blank structure onto the forming wire by the blank dry-forming module,
feeding the air-formed cellulose blank structure into a pressing area defined by the first and second, spaced apart, mold parts,
controlling operation of the pressing actuator arrangement by the electronic control system for performing pressing operations, which involves driving the pressing member in the pressing direction by the toggle-mechanism, and thereby forming the non-flat cellulose product from the air-formed cellulose blank structure by pressing the first mold part against the second mold part, and
controlling operation of the forming wire by the electronic control system for intermittently feeding the forming wire between subsequent pressing operations.

13. The method according to claim 12, comprising controlling operation of the forming wire by the electronic control system for intermittently feeding the forming wire between subsequent pressing operations, such that the forming wire is operated periodically with a relatively high speed during time periods between subsequent pressing operations, and with a relatively low speed, or zero speed, during time periods coinciding with pressing operations.

14. A method according to claim 12, wherein the toggle press further includes a pressing force indicating arrangement, an adjustment mechanism for enabling adjustment of a distance between the first and second mold parts in the pressing direction while having the toggle-mechanism in a non-moving operating state, and an adjustment actuator arrangement configured for driving the adjustment mechanism, wherein the method comprises controlling operation of the adjustment actuator arrangement based on pressing force indicating feedback information received from the pressing force indicating arrangement.

15. The method according to claim 14, wherein the method comprises controlling operation of the adjustment actuator arrangement for adjusting the distance between the first and second mold parts during a time period between consecutive pressing actions, such that the pressing member during the next pressing cycle is targeted to provide a compression force closer to a predetermined target pressing force.

16. The method according to claim 12, wherein the step of air-forming the cellulose blank structure from the cellulose raw material in the blank dry-forming module involves: separating fibers from the cellulose raw material in a mill and distributing the separated fibers onto a forming wire of the blank dry-forming module for forming the cellulose blank structure, and transporting the formed cellulose blank structure in the upwards blank forming direction.

17. The method according to claim 12, wherein the cellulose blank structure is intermittently transported from the blank dry-forming module by the forming wire in a first feeding direction, and intermittently transported to the pressing module in a second feeding direction, wherein the second feeding direction differs from the first feeding direction, specifically wherein the second feeding direction is opposite to, or essentially opposite to, the first feeding direction.

18. The method according to claim 12, wherein the step of forming the cellulose products from the cellulose blank structure in the forming mold involves heating the cellulose blank structure to a forming temperature in the range of 100-300° C., and pressing the cellulose blank structure with a forming pressure in the range of 1-100 MPa.

19. A cellulose product toggle pressing module for forming non-flat cellulose products from an air-formed cellulose blank structure, the toggle pressing module comprising:
a toggle press including a pressing member movably arranged in a pressing direction, a toggle-mechanism drivingly connected to the pressing member, a pressing actuator arrangement drivingly connected to the toggle-mechanism for controlling motion of the toggle-mechanism between a retracted operating position and an extended operating position,
a forming mold including a moveable first mold part attached to the pressing member and a second mold part,
an adjustment mechanism for enabling adjustment of a distance in the pressing direction between the first and second mold parts while having the toggle-mechanism in a non-moving operating state and an adjustment actuator arrangement configured for driving the adjustment mechanism,
a pressing force indicating arrangement, and
an electronic control system operatively connected to the pressing force indicating arrangement, the pressing actuator arrangement and the adjustment actuator arrangement,
wherein the electronic control system is configured for controlling operation of pressing actuator arrangement for driving the pressing member in the pressing direction by setting the toggle-mechanism in the extended operating position, and thereby forming the non-flat cellulose product from the air-formed cellulose blank structure by pressing the first mold part against the second mold part, and
wherein the electronic control system is configured for controlling operation of the adjustment actuator arrangement, based on pressing force indicating feedback information received from the pressing force indicating arrangement.

20. The product forming unit according to claim 19, wherein the electronic control system is configured to control operation of the adjustment actuator arrangement for adjusting the distance between the first and second mold parts during a time period between consecutive pressing actions, such that the pressing member during the next pressing cycle is targeted to provide a compression force closer to a predetermined target pressing force.

21. A method for forming non-flat cellulose products from an air-formed cellulose blank structure in a toggle pressing module comprising a toggle press including a pressing member movably arranged in a pressing direction, a toggle-mechanism drivingly connected to the pressing member, a pressing actuator arrangement drivingly connected to the toggle-mechanism for controlling motion of the toggle-mechanism between a retracted operating position and an extended operating position, a forming mold including a moveable first mold part attached to the pressing member and a second mold part, an adjustment mechanism for enabling adjustment of a distance between the first and second mold parts in the pressing direction while having the toggle-mechanism in a non-moving operating state, and an adjustment actuator arrangement configured for driving the adjustment mechanism, a pressing force indicating arrangement, and an electronic control system operatively connected to the pressing force indicating arrangement, the pressing actuator arrangement and the adjustment actuator arrangement, wherein the method comprises:
air-forming a cellulose blank structure onto the forming wire by the blank dry-forming module,
feeding the air-formed cellulose blank structure into a pressing area defined by the first and second, spaced apart, mold parts,
controlling operation of the pressing actuator arrangement for performing pressing operations, which involves driving the pressing member in the pressing direction by setting the toggle-mechanism in the extended operating position, and thereby forming the non-flat cellulose product from the air-formed cellulose blank structure by pressing the first mold part against the second mold part,
controlling operation of the adjustment actuator arrangement, based on pressing force indicating feedback information received from the pressing force indicating arrangement.
